(19) United States
(12) Patent Application Publication
(10) Pub. No.: US 2005/0141843 A1
(43) Pub. Date: Jun. 30, 2005

(54) Waveguide comprising scattered light detectable particles

(75) Inventors: Laurence Warden, Poway, CA (US); Paul J. Bushway, San Diego, CA (US); Todd C. Peterson, Coronado, CA (US); Kris Rolfson, San Diego, CA (US)

Correspondence Address: JONES DAY, 222 EAST 41ST ST, NEW YORK, NY, 10017, US

(73) Assignee: Invitrogen Corporation

(21) Appl. No.: 10/749,348

(22) Filed: Dec. 31, 2003

(51) Int. Cl. G02B 6/10

(52) U.S. Cl. 385/141; 385/129

(57) ABSTRACT

A waveguide comprising light scattering particles is described. The invention encompasses methods of making the waveguide, using the waveguide in analyte assays, and apparatus for detection of light scattered by light scattering particles in the waveguide.

### 1. INTRODUCTION

The present invention relates to the field of analyte assays using detectable labels, with particular application to assays using light scattering particle labels and waveguide.

### 2. BACKGROUND OF THE INVENTION

With the recent advances in biochemistry and molecular genetics, much knowledge and information have been accumulated regarding the human body and its processes. There is a great urgency to translate this knowledge into healthcare applications and to further our understanding of various diseases. Thus, there is a great need for quantitative, multi-analyte, and inexpensive procedures and instruments for the detection of analytes. Such procedures, test kits, and instruments would be useful in research, individual point of care situations (doctor's office, emergency room, out in the field, etc.), and in high throughput testing applications.

The use of chromogenic labels, radioactive labels, chemiluminescent labels, fluorescent labels, light absorbing labels, and light scattering labels in analyte assays is well known. In particular, the recent developments in the use of resonance light scattering (RLS) particle labels and signal detection technologies have enabled a whole range of analytical applications ranging from single analyte assays, multiple analyte assays to in situ labeling of histological sections and cells.

Such RLS particle labels and their use, especially in analyte assays, are described in Yguerabide et al., U.S. Pat. No. 6,214,560, U.S. Pat. No. 6,586,193, PCT/US/97/06584 (WO 97/40181 and Yguerabide et al., PCT/US98/23160 (WO 99/20789), and U.S. patent application Ser. No. 10/084,844, by Yguerabide et al., entitled “Methods For Providing Extended Dynamic Range in Analyte Assays,” filed Feb. 25, 2002, all of which are incorporated herein by reference in their entireties, including drawings. Elements of the technology are also described in two related articles by Yguerabide & Yguerabide, (1998) Anal. Biochem. 261:157-176; and (1998) Anal. Biochem. 262:137-156, which are likewise incorporated herein by reference in their entireties.

Similar methods utilizing light scattering (referred to as “plasmon resonance”) labels in assays are also described in Schultz, et al, PCT/US98/02995 (WO 98/37417) and U.S. Pat. No. 6,180,415. Other techniques utilizing scattered light are also known. For example, Swope et al., U.S. Pat. No. 5,350,697 describes apparatus to measure scattered light by having the light source located to direct light at less than the critical angle toward the sample. The detector is located to detect scattered light outside the envelope of the critical angle. De Mey et al., U.S. Pat. No. 4,446,238, describes a similar bright field light microscopic immunocytochemical method for localization of colloidal gold labeled immunoglobulins; the optical absorption signal generation system produces a red colored marker in histological sections. DeBrabander et al., U.S. Pat. No. 4,752,567 describes a method for detecting individual metal particles of a diameter smaller than 200 nm by use of bright field or epi-polarization microscopy and contrast enhancement with a video camera is described.

DeBrabander et al., (1986) Cell Motility and the Cytoskeleton 6:105-113, (and U.S. Pat. No. 4,752,567) describe use of submicroscopic gold particles and bright field video contrast enhancement. Specifically, the cells were observed by bright field video enhanced contrast microscopy with gold particles of 5-40 nanometers diameters. The authors described use of epi-illumination with polarized light and collection of reflected light or by use of transmitted bright field illumination using monochromatic light and a simple camera.

In the Yguerabide methods of using RLS particle labels (see, for example, U.S. Pat. Nos. 6,214,560 and 6,586,193), the detection and/or measurement of the light-scattering properties of the particle is correlated to the presence, and/or amount, or absence of one or more analytes in a sample. Such methods include detection of one or more analytes in a sample by binding those analytes to at least a population of detectable light scattering particle, with a size preferably smaller than the wavelength of the illumination light. The particles are illuminated with a light beam under conditions where the light scattered from the beam by the particle can be detected by the human eye with less than 500 times magnification. The light that is scattered from the particle is then detected under those conditions as a measure of the presence of those one or more analytes. By simply ensuring appropriate illumination and ensuring maximal detection of specific scattered light, an extremely sensitive method of detection can result.

The use of evanescent wave light for illumination of particles for analyte detection and for monitoring reaction kinetics have also been described. Stimpson U.S. Pat. No. Nos. 5,599,668, and 5,843,651, and Schutt U.S. Pat. No. No. 5,017,009 describe an evanescent wave illumination and detection method that is specific to analytes and aqueous solutions being in contact with a transparent substrate. Evanescent wave light exists on the surface of the substrate, and extends only a finite distance in a direction perpendicularly away from the surface, when light inside the substrate is propagating through total internal reflection.

In particular, Stimpson et al. U.S. Pat. No. Nos. 5,599,668, and 5,843,651 (“Stimpson”) describe an analyte detection method where a single type of colloidal particle is bound to multiple sites on a substrate, which is then covered in a solution with a lower index of refraction than the substrate. Light directed into the substrate at an angle greater than a critical angle will be totally internally reflected at the interface between the substrate and the solution, with only the evanescent wave light extending a finite distance into the aqueous layer. In the practice of Stimpson's analyte detection method, the refractive index of the aqueous medium bathing the particles is less than the refractive index of the substrate.

Schutt et al., U.S. Pat. No. 5,017,009, describes an immunoassay system for detection of ligands or ligand binding partners in a heterogenous format. In this system back scattered light from an is based upon detection of an evanescent wave disturbed by the presence of a label is detected by a light sensor. The immunoassay system described utilizes scattered total internal reflectance, i.e., propagation of evanescent waves. Schutt et al. indicate that the presence of colloidal gold disrupts propagation of the evanescent wave resulting in scattered light, which may be detected by a photomultiplier or other light sensor to provide a responsive signal. An important aspect of the device disclosed in Schutt is the physical location of the detector, which is placed at an angle greater than the critical angle and in a location whereby only light scattered backward toward the light source is detected.

Light scattering particles have also been introduced inside an optical fiber so that the fiber acts as a polarizer. Bloemer et al., U.S. Pat. No. 5,151,956, describes the use of light scattering particles in optical fibers to selectively absorb (and scatter) the transverse electric (TE) polarization mode, and allow only the desired transverse magnetic (TM) polarization mode to propagate along the fiber, i.e., to selectively polarize light propagating through the structure. The reference discloses using non-spherical (i.e., elongated) light scattering particles that are oriented so that their major axes are parallel to, and their minor axes are perpendicular to, the surface of the fiber. When the electric field of the laser beam is parallel to the major axes of the light scattering spheroids, the TE guided light mode is fully absorbed (and scattered), while the TM mode is passed.

### 3. SUMMARY OF THE INVENTION

The present invention provides a waveguide, methods of use of the waveguide for analyte assays, and an apparatus for detecting scattered light from the waveguide.

In one embodiment, the waveguide of the invention is formed from at least two optically transmissive materials that form an interface, wherein the refractive index of one of the optically transmissive materials (a second material) is greater than or equal to the refractive index of the other optically transmissive material (a first material). One or more distinguishable populations of scattered light detectable particles of a dimension between 1 and 500 nm inclusive that are bound to an analyte are distributed in the second material such that the particles are illuminated by non-evanescent light and produce detectable scattered light in said waveguide.

In another embodiment, the method employs more than one population of scattered light detectable particles, wherein each population of particles has a particle type configuration distinguishable from the other populations by their predetermined scattered light detectable properties, and each population would bind to a different predetermined analyte.

These particles can include a metal, a metal compound, a semiconductor, or a superconductor. Preferably, the particles include gold, silver, or both gold and silver. In preferred embodiments, the particles exhibits plasmon resonant light scattering. The populations of particles can separately be spherical, non-spherical, symmetric, asymmetric, elliposoidal, cylindrical, cubical, tetrahedral, polyhedral, or pyramidal in shape. The dimension of the particles are preferably in the range of 10 to 200 nm inclusive, 20 to 200 nm inclusive, 40 to 120 nm inclusive, 80 to 120 nm inclusive, 1 to 10 nm inclusive, 11 to 40 nm inclusive, 100 to 250 nm inclusive, or 40 to 80 nm inclusive. Preferably, within each population of scattered light detectable particles, the dimensions of the particles are uniform, i.e., each population exhibits a narrow size distribution such that populations of particles of different dimensions can be distinguished by the respective light scattering properties of the populations. In a specific embodiment, the particles could form aggregates, and light scattered by the aggregates is detectably different from light scattered by individual particles.

The analyte can be a chemical entity or a biological entity, such as but not limited to a polynucleotide, a DNA molecule, a RNA molecule, a PNA molecule, a polypeptide, a carbohydrate, a glycoprotein, a lipid, a glycolipid, a combinatorially-synthesized molecule, a natural product, a pharmaceutical agent, a chromosome, a cell organelle, a virus, a bacterium, a protozoan, a fungus, a pathogen, a microorganism, a single cell organism, or a cell of a multicellular organism.

The scattered light detectable particles could be bound to a probe that binds the analyte directly, or the particles could be indirectly bound to an analyte via a probe and one or more members of at least one secondary binding pair. Examples of members of a secondary binding pair include but are not limited to an antigen, a hapten, a polyclonal antibody, a monoclonal antibody, a lectin, a carbohydrate, a polynucleotide, a peptide, an antibody to a peptide, a receptor, biotin, avidin, streptavi din, digoxigenin, an anti-digoxigenin antibody, fluorescein, or an anti-fluorescein antibody.

The optically transmissive materials used to form the waveguide can separately comprise minerals, glass, plastic, and/or an optical polymer. The optical, chemical, and mechanical properties of such materials are well known. Depending on the type and format of the analyte assay, and the detection and storage requirements, the choices of optically transmissive materials used to form the waveguide can be made by one skilled in the art.

In various embodiments, one or more surfaces or edges of the waveguide can be adapted to receive light and to couple light into the waveguide. For example, one or more surfaces of the waveguide can be coupled to a prism, coupled to an optical grating, or be coated with a reflective material. Also, one or more surfaces of the waveguide can be adapted to couple scattered light from the waveguide to a sensor or an eyepiece.

The waveguide can be planar or curvilinear. In preferred embodiments, the waveguide is a planar structure. One of the optically transmissive layers can be configured to include one or more spatially discrete, and preferably individually addressable sites. The scattered light detectable particles can be deposited on the surface of a layer of material with lower refractive index (a first layer) that forms an interface with a second layer of material with equal or higher refractive index. Alternatively, the lower refractive index layer can be sandwiched between layers of refractive index materials of equal or higher refractive index. In preferred embodiments, the lower refractive index layer is a slide, wherein one or more surfaces or edges of the slide could be adapted, configured, or oriented to couple light into the waveguide. A coating with an equal or higher refractive index is applied to the slide (the first layer) to form the second layer. In one specific embodiment, the first layer comprises silica and the second layer comprises an acrylic, a polyurethane, or beta-pinene. In a preferred embodiment, the first layer comprises glass, and the coating comprises an aqueous organic polymer, such as polyvinyl alcohol.

In another embodiment, the present invention provides a method for detecting an analyte in a sample. The method includes the steps of (a) contacting a sample with one or more populations of scattered light detectable particles that bind to said analyte, where the particles are of a dimension between 1 and 500 nm inclusive; (b) forming a planar waveguide having an interface between a first optically transmissive layer and a second optically transmissive layer, where the particles are present in the second layer, and where the refractive index of said second layer is greater than or equal to the refractive index of the first layer; (c) illuminating the particles in the waveguide with non-evanescent light under conditions which produces scattered light from said particles; and (d) detecting the light scattered by (i) the populations of particles bound with analyte; or (ii) the populations of particles not bound with analyte; or (iii) both (i) and (ii), as a measure of the presence of the analyte in the sample.

The invention also provides alternate methods of forming the waveguide including one or more distinguishable populations of scattered light detectable particles. The step of forming the waveguide can include contacting the first optically transmissive layer with a precursor of the second optically transmissive layer which is in liquid phase or gaseous phase. The step of forming the waveguide can also include curing and/or hardening of the second optically transmissive layer. The sample, the particles, or both the sample and the particles can be deposited on a surface of the first optically transmissive layer prior to contacting the sample with the one or more populations of scattered light detectable particles. The particles can be deposited on a surface of a first optically transmissive layer prior to forming the waveguide, such that the particles are present at or near the interface. Also, the particles can be distributed in the second optically transmissive layer or a precursor of the second optically transmissive layer, prior to forming the waveguide.

In another embodiment, the invention provides alternate methods of illuminating the particles in the waveguide with non-evanescent light. Preferably, the step of illuminating to particles produces scattered light from the particle and in which light scattered from one or more the particles can be detected by a human eye with less than 500 times magnification and without electronic amplification. Monochromatic light, polychromatic light, white light, sunlight, or laser light can be used for illuminating the particles. The incident light can be non-polarized, polarized, pulsed, constant, coherent, or noncoherent. The illuminating light can be provided using a filament lamp source, a discharge lamp source, a laser, or a light emitting diode. The illuminating light can be coupled from a light source into the waveguide at an angle that creates total internal reflection at one or more exterior surfaces of the waveguide but not at the interfaces of the first layer and the second layer. The illuminating light can be coupled from a light source initially into the first layer of the waveguide. The illuminating light can also be provided by one or more light emitting diodes that are focused along an edge of the waveguide using one or more optical elements. Thus, the particles in the waveguide can be illuminated by direct light from a light source and/or reflected light resulting from total internal reflection within the waveguide. Evanescent light generated by total internal reflection is not used to illuminate the particles since the particles reside in the medium that has a higher refractive index.

The invention also provide different modes of detecting the light scattered by the populations of particles. The step of detecting can include magnification with a microscope 2 to 500 times or 10 to 100 times. An integrated light intensity measurement can also be provided for the step of detecting. The scattered light can be detected by first forming an image, and then viewing the image, recording the image, and/or analyzing the image by a computer. The step of detecting could include the use of a film camera, a video camera, confocal microscopy, a photodiode, a photodiode array, a photomultiplier tube, a complementary metal-oxide semiconductor (CMOS) device, or a charge-coupled device.

In yet another embodiment, the present invention provides an apparatus for illuminating a planar waveguide, and detecting scattered light produced by scattered light detectable particles in the waveguide. The apparatus includes a holder adapted to hold a planar waveguide (with or without the waveguide in the holder); an illumination system including a light source directed at the waveguide; and a scattered light detection system cooperating with the holder and illumination system to detect light scattered from the particles, where the waveguide includes a first optically transmissive layer that forms an interface on at least one side with a second optically transmissive layer, such that scattered light detectable particles in the waveguide are illuminated by non-evanescent light. Optionally, the holder can include X and Y stages for precisely positioning the waveguide with respect to the illumination system and the detection system.

In various embodiments, the illumination system of the apparatus can include one or more optical elements such that light from the light source is directed at a target surface of the waveguide at an angle that creates total internal reflection at one or more exterior surfaces of the waveguide but not at the interfaces of the first layer and the second layer. The illumination system can also include a plurality of light emitting diodes focused on a target surface of the waveguide. When the illumination system includes a broad-band light source, the apparatus can also include a plurality of individually selectable spectrally discriminative light filters disposed in at least one of the illumination system or detection system. In yet another embodiment, the illumination system includes a light source and cylindrical lens configured to focus a line of light along an edge of the first layer of the waveguide.

In various embodiments, the detection system of the apparatus can include an eyepiece, a film camera, a video camera, a photomultiplier, a photodiode, a photodiode array, a CMOS device, or a charge coupled device. In a specific embodiment, the detection system includes a light detector focused on a surface of the waveguide proximate to the second layer, and defines a field of view or focal plane extending from the surface, into the second layer of the waveguide and terminating at or before the interface with the first layer.

In a preferred embodiment, the apparatus is configured to receive a slide or similar transparent solid phase which is illuminated by LEDs that are positioned with a lens along an edge of the slide. The apparatus is preferably dimensioned to be handheld, and that different areas of the slide can be viewed by eye through interchangeable eyepieces or lens, or imaged by an imaging device attached to an eyepiece or lens.

### 4. BRIEF DESCRIPTION OF THE DRAWINGS

FIGS. 1A, B and C illustrate the real and imaginary parts of the refractive index of gold, silver and selenium, respectively.

FIG. 2 illustrates the relative scattering cross-section vs. wavelength in nanometers for various spherical metal particles.

FIGS. 3A and 3B illustrate the normalized scattering cross-section vs. wavelength in nanometers for silver particles of size 20-100 nm, and 100-140 nm, respectively.

FIGS. 4A and 4B illustrate the normalized scattering cross-section vs. wavelength in nanometers for gold particles of size 20-140 nm, and 160-300 nm, respectively.

FIGS. 5A, 5B, and 5C show diagrams of MLSP (Manipulatable Light Scattering Particle) mixed composition particles. FIG. 5A (1) illustrates a core magnetic or ferroelectric material coated with (2)the desired light scattering material; FIG. 5B shows (4) a light scattering material core coated with (3) magnetic or ferroelectric material; FIG. 5C shows a mixture of (5) light scattering material with (6) magnetic or ferroelectric material.

FIGS. 6A, 6B, and 6C show dimer, tetramer, and higher order particle constructs respectively for orientable MLSP particles. Light scattering detectable particles are labeled (1) and magnetic or ferroelectric particles are labeled (2). The line. (3) is the linkage chemical, ionic, or other that binds the particles together in the multi-particle construct.

FIG. 7 illustrates the particle type configurations considered when selecting particles with the desired light scattering properties.

FIG. 8 illustrates the angles of reflection and refraction at a surface S, which is the interface between media with two different indices of refraction (nᵢ and nₜ), where the illuminating light beam is incident on the interface from medium nᵢ. RFRB and RFLB are the refracted and reflected light beams respectively; IB is the incident light beam; θᵢ, θᵣ, and θₜ are the angles of incidence, reflection, and refraction of the light beam.

FIGS. 9A, 9B, and 9C illustrate light reflection behavior at the interface for nᵢ<nₜ.

FIGS. 10A, 10B and 10C illustrate light reflection behavior at the interface for ni>nt.

FIG. 11 illustrates the refraction and reflection of light involved in the illumination of particles on a dry surface in air.

FIG. 12 is a graph of plot of θᵢ2 vs. θᵢ1 for n₂=1.5 and n₃=1.

FIG. 13 illustrates two different light paths across an interface in a system comprising three different layers with refractive index n₁ (layer 1), n₂ (layer 2), and n₀ (layer 3), where n₀<n₂ , and n₂≧n₁.

FIGS. 14A and 14B illustrate alternative embodiments of waveguides according to the present invention, showing the behavior of light at an interface for the case where n₁=n₂ and there is total internal reflection (TIR) inside the waveguide, where the waveguide comprises both materials n₁ and n₂, and the evanescent wave light extends outside the waveguide, i.e., the outer surface of material n₂.

FIG. 15 is a schematic cross-sectional view of a hand-held device for viewing samples according to the present invention.

FIG. 16 is a circuit schematic of an exemplary embodiment of the device shown in FIG. 15.

FIGS. 17A and 17B are perspective views illustrating alternative embodiments of hand-held devices according to the invention.

FIG. 18 is an embodiment of a scanning instrument and system according to the invention.

FIG. 19 is a side view of a slide holder for use in the instrument of FIG. 18.

FIGS. 20 and 21 are images of sample slides created with a scanning system as shown in FIGS. 18 and 19.

FIG. 22 shows eight rows of positive, negative, hybridization and ratiometric controls used in a two color array.

FIG. 23A shows the printing layout of the slide and FIG. 23B shows the concentrations of cytokines per array on the slide.

FIG. 24 is an image of the slide after the protein assay was completed.

### 5. DETAILED DESCRIPTION OF THE INVENTION

The present invention relates to compositions, devices, and methods for analyte detection that are based on light scattering particles.

A description of the theory of light scattering and the basis of analyte assays that uses light scattering particle as labels is provided in Section 5.2 herein below and in Yguerabide et al., 1998, Analytical Biochemistry 262:137-156 and 262:157-176, U.S. Pat. Nos 6,180,415, 6,214,560 and 6,586,193, which are incorporated herein by reference. As described in details in Section 5.2, the light scattering particles are preferably resonance light scattering (RLS) particles. One clear advantage of the RLS particle labels, especially metal particles, is their stability. Unlike fluorescent labels which are subject to bleaching and fading, and radioactive labels many of which have relatively short half-lives, the use of RLS particle labels afford the ability to obtain reproducible readings over a long period of time. While the use of light scattering particles as labels overcame major disadvantages of other types of labels, the inventors have improved assays based on such labels by providing devices and methods that facilitate better illumination of the light scattering particles and collection of light scattered by the light scattering particles.

In one embodiment, the invention provides a waveguide comprising light scattering particles. In another embodiment, the invention provides methods of using a waveguide and light scattering particles in single and multiple analyte detection assays. The methods generally comprise coupling light into the waveguide thereby illuminating the light scattering particles with non-evanescent light and detecting light scattered by the particles. In various embodiments, the waveguides of the invention are formed by combining two different optically transmissive material which form an interface, and in particular, by contacting a light-propagating material of refractive index n₁ with another light-propagating material of refractive index n₂, where n₂ is greater than or equal to n₁. The materials n₁ or n₂ can be solid, liquid, glassy, polymeric, etc. The material n₁ and/or n₂ can remain in the same physical phase, or it can change physical phase during the formation of the waveguide, e.g. from liquid to solid, or from polymeric to glassy, etc. The scattered light detectable particles can be at the interface of materials n₁ and n₂, or they can be present in either material n₁ or n₂ or both materials n₁ and n₂. The waveguides of the invention and methods of forming the waveguides are described in details in Section 5.1. The methods of its use are described in details in Section 5.4.

As used herein, the term “label” refers generally to an entity that is used to identify an object of interest, and in most instances, trace the object through a physical, chemical or biological process. In preferred embodiments, the label is detectable by photons emanating from the label. Examples of labels include but are not limited to dyes, stains, chromophores, fluorophores, fluorescent molecules, luminescent molecules, chemiluminescent molecules, bioluminescent molecules, phosphorescent molecules, quantum dots. Preferred examples of labels include but are not limited to R-Phycoerythrin, Alexa Fluor 647, Alexa Fluor 680, DilC19(3), Rhodamine Red-X, Aleza Fluor 660, Alexa Fluor 546, Texas Red, YOYO-1+DNA, Tetramethylrhodamine, Alexa Fluor 594, BODIPY FL, Alexa Fluor 488, Fluorescein, BODIPY TR, BODIPY TMR, carboxy SNARF-1, FM 1-43, Fura-2, Indo-1, Cascade Blue, NBD, DAPI, Alexa Fluor 350, Aninomethylcoumarin, Lucifer yellow, Propidium iodide, and Dansylamide. Many other examples of labels which can be used in the waveguide of the invention are disclosed in the following U.S. Pat. Nos. 4,774,339, 4,945,171, 5,132,432, 5,167,288, 5,227,487, 5,242,805, 5,248,782, 5,262,545, 5,274,113, 5,314,805, 5,316,906, 5,321,130, 5,326,692, 5,338,854, 5,362,628, 5,364,764, 5,405,975, 5,410,030, 5,433,896, 5,436,134, 5,437,980, 5,442,045, 5,443,986, 5,445,946, 5,451,663, 5,453,517, 5,459,268, 5,49,276, 5,501,980, 5,514,710, 5,516,864, 5,534,416, 5,545,535, 5,573,909, 5,576,424, 5,582,977, 5,616,502, 5,635,608, 5,635,608, 5,648,270, 5,656,449, 5,658,751, 5,686,261, 5,696,157, 5,719,031, 5,723,218, 5,773,227, 5,773,236, 5,786,219, 5,798,276, 5,830,912, 5,846,737, 5,863,753, 5,869,689, 5,872,243, 5,888,829, 6,005,113, 6,130,101, 6,162,931, 6,229,055, 6,265,179, 6,291,203, 6,31,267, 6,323,337, 6,329,205, and 6,329,392, which are incorporated herein by reference in their entireties.

Most preferably, the labels are light scattering particles. As used herein, the terms “scattered light detectable particle” and “light scattering particle” are used interchangeably to refer to any particle or particle-like substance that is composed of metals, metal compounds, semiconductors, superconductors, or a particle that is composed of a mixed composition containing at least 0.1% by weight of metals, metal compounds, semiconductors, or superconductor material. “Resonance light scattering (RLS) particles,” also known in the art as plasmon resonant particles, are a preferred type of light scattering particles.

The term “sample” refers to the material that is being analyzed or assayed. A sample may comprise one or more analytes of interest, as well as one or more labels used in the assay. The term also encompasses negatives and negative controls that do not comprise the analyte of interest.

As used herein, the term “sample device” refers to a physical item that retains a sample for identification or analysis. Typically, the sample device is configured with surface or surfaces on which sample(s) are retained. Preferably, a plurality of surfaces or zones are available on a sample device for analysis of multiple samples. The term “substrate” is also used to refer to the surface on which the sample and/or label is present. In certain embodiments, an entire surface of or discrete zones on the sample device are functionalized by methods known in the art to facilitate binding of molecules involved in an analyte assay, such as but not limited to analytes, analyte-binding molecules, probes, etc. Non-limiting examples of sample devices include slides, chips, plates, microtiter plates, and membranes. A sample device can form part of the waveguide of the invention and vice versa depending on the configuration of the assay.

As used herein in connection with sample devices or other solid phase items, the term “chip” refers to a substantially planar solid substrate with surface area of approximately 3 in² in the case of a 1 inch×3 inch microscope slide or 1 in² or less for some other microarray formats. In some cases, planar substrates with a surface area greater than 3 in², for example a planar substrate in the two dimensional configuration of a microtitre plate footprint, can be uses. Preferably the substrate is optically clear, e.g., glass or plastic although other material supports can be used.

As used in connection with sample devices or other solid phase items, the term “slide” refers to a generally planar solid substrate with a surface area greater than 1 in2 up to 4 in² inclusive. Preferably the substrate is optically transmissive. Glass microscope slides with dimensions approximately 1 inch by 3 inches are an example. While slides with surfaces that are substantially uniformly planar are preferred, slides may have depressions, permanently attached or removable well structures, or other surface structures useful or not preventing use of the slide in the intended assay.

Likewise, the term “plate” refers to a solid substrate with a generally planar surface having an area greater than 4 in². The plate may be substantially uniformly planar, or may have depressions, attached well structures, or other structural features. In some embodiments, the plate has depressions, e.g., wells, for containing liquids, for example, microtiter plates (e.g., 96-well, 192-well, and 384-well plates). In other embodiments, a plate may have either permanently mounted or removable well structures affixed to the surface of the plate.

### 5.1 WAVEGUIDES

In one embodiment, the invention provides a waveguide for illuminating light scattering particles with non-evanescent light. In another embodiment, the invention provides methods of forming such a waveguide comprising light scattering particles.

A waveguide of the invention comprises a combination of two different light-propagating materials which is organized in two discrete layers that permits light to pass from one material to the other material. The first light-propagating material of refractive index n₁ forms an interface S_{1/2} with the second light-propagating material of refractive index n₂, where n₂ is greater or equal to n₁. In various embodiments, the light scattering particles are distributed in the waveguide, for example, distributed (i) at the interface of the two light-propagating layers, (ii) in the first light-propagating layer, (iii) in the second light-propagating layer, or combinations thereof. The light scattering particles may or may not be bound to a sample or an analyte of interest. The waveguide also comprises one or more surfaces for coupling light into the waveguide by a variety of methods known in the art. The waveguide also comprises one or more surfaces for detecting light scattered by the light scattering particles in the waveguide, including means for coupling scattered light out of the waveguide. The waveguide can be given any dimension and be shaped in any way by techniques known in the art to fit the requirements of a particular assay, an assay format, a light source, and/or a light sensor, and still allow guidance of one or more optical modes. The waveguide can have different topologies, e.g., it can be planar or it can exhibit some curvature. In preferred embodiments, the waveguide is planar in topology, which can facilitate optimal detection of light scattered by RLS particle labels. A waveguide can be a sample device, or a number of waveguides can be assembled to form a sample device.

The first and second light-propagating materials can separately be solid, liquid, glassy, or polymeric. The material n₁ and/or n₂ can remain in the same physical phase, or it can change physical phase, e.g. from liquid to solid, or from polymeric to glassy, etc., after the waveguide is formed or as a result of the formation of the waveguide. Preferably, the material n₁ is solid. Preferably, the material n₂ is not a fluid. Processes involved in the change of physical phase of the waveguide material include, but are not limited to, curing and drying. Methods for applying such coatings and compositions of the coatings are described in U.S. patent application Ser. No. 09/948,058, filed Sep. 5, 2001, and Ser. No. 10/236,888, filed Sep. 5, 2002, both of which are incorporated herein by reference in their entireties, including tables and drawings.

When light enters a light-propagating multilayered structure, the path of the light wave within the structure will depend on the refractive index of each layer and on the relationship of the refractive indices of the materials that make up an interface of two layers. If, at any interface formed between two light-propagating material where one has a higher refractive index than the other, and the light is incident on the interface after propagating through the medium of higher refractive index, then under defined circumstances the light is reflected back into the medium of higher refractive index. The fraction of light reflected at an interface depends on the incident angle, and on the refractive indices of the two media creating the interface. This is the general principle exploited in forming a waveguide of the present invention.

The following is a brief discussion of the fundamental laws of refraction and reflection.

### 5.1.1 Laws of Refraction and Reflection

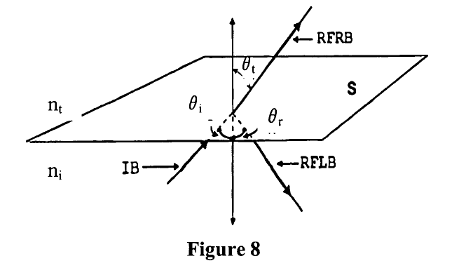

Snell's law of refraction is described in terms of FIG. 8 which shows a light beam that travels along a medium of refractive index nᵢ (i for incident medium) and impinges on the interface S with a medium of refractive index nₜ (t for transmission medium). Part of the incident light is transmitted into medium t (the refracted beam) and part is reflected (the reflected beam) back into medium i. If the angle of incidence θᵢ is less than a critical angle, then some of the incident light is transmitted across the interface into medium t as a refracted beam at angle θₜ, and some is reflected back into medium i at angle or. The relationship of the angle θᵢ to θₜ is given by Snell's Law, which can be written as
nᵢ sin (θᵢ)=nₜ sin (θₜ) (1)
If nᵢ<nₜ then θᵢ>θₜ. If nᵢ>nₜ then θᵢ<θₜ. Note that angles are measured with respect to a line that is perpendicular to the interface S. The reflected beam makes the same angle to the interface as the incident beam, i.e., θᵣ=θᵢ.

The fraction R of incident light intensity which is reflected for different incident angles θᵢ can be calculated using Fresnel's equations of reflection. (It should be noted that intensity is here defined as energy per unit time per unit area. Intensity is also called irradiance). However for simplification, the discussion is presented in terms of plots relating R to θᵢ. The exact dependence of R on θᵢ is determined by the values of nᵢ and nₜ and the state of polarization of the incident light. Important facts concerning reflectance are as follows.

i. Reflectance for the Case Where the Light Beam Travels from a Medium of Low Refractive Index to one of High Refractive Index (ni<nt).

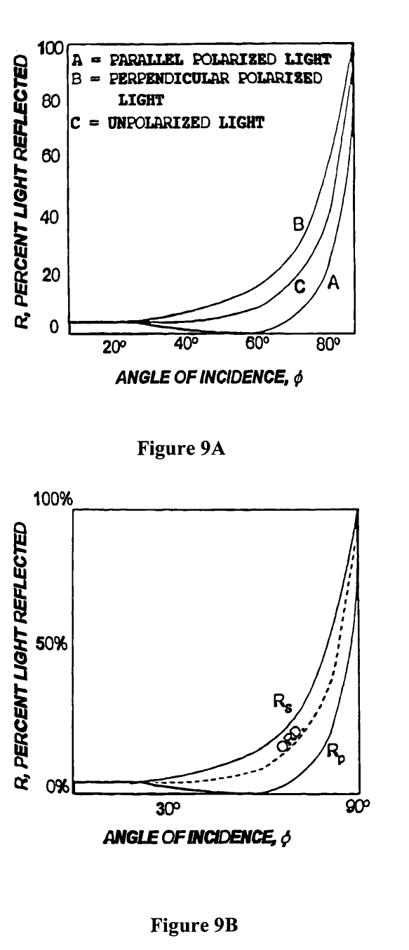

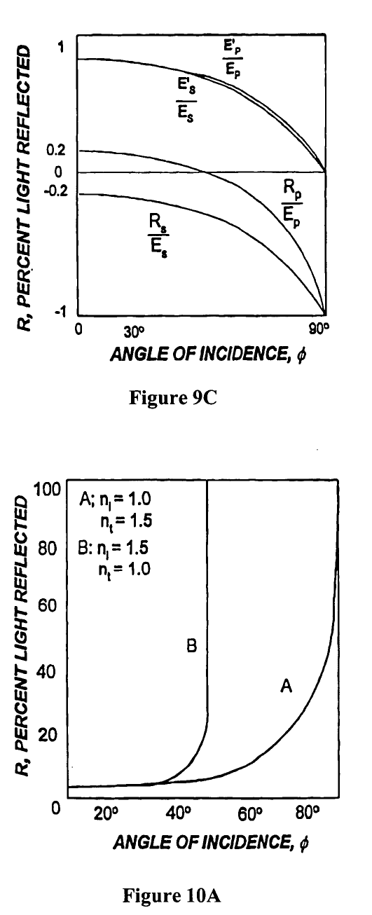

FIG. 9 shows plots of R vs. θᵢ (θ=θᵢ) for the case where nᵢ=1 (air) and nₜ=1.5 (the latter is close to the refractive index of glass or plastic) and for light polarized parallel (rp) and perpendicular (rs) to the plane of incidence. The plane of incidence is defined as the plane which contains the incident light beam and the line perpendicular to the surface (see FIG. 8). The reflectance R of unpolarized light is given by the average of the graphs for light polarized parallel and perpendicular to the plane of incidence. In FIG. 9, the reflectance graph for unpolarized light is labeled Ord (for ordinary). The graphs of FIG. 9 show that:
a. rs increases continuously with increasing φ in FIG. 9 is the same as θᵢ as used herein). The increases in rs is small up to about 70° (where the reflectance is only about 15%) and then increases much more rapidly reaching 100% reflectance at 90°. Thus, the fraction of light that is reflected is less than 20% up to incidence angles of 60°.
b. rp decreases with increasing φ up to about 57° where rp is zero. The angle at which rp=0 is called the Brewster angle or polarizing angle. The Brewster angle θ_{b} can be calculated with the expression
   Tan (θ_{b})=nₜ (2)
   assuming that nᵢ=1 (air). For nₜ=1.5, above equation gives θ_{b}=56.3. It should be noted that at the Brewster angle, θᵢ+θₜ=90°. Thus for nₜ=1.5, θᵢ=θ_{b}=56.3° and θₜ=33.7°. For angles greater than the Brewster angle, rp increases rapidly with increase in φ and reaches a value of 100% at 90°.
c. For unpolarized (ordinary light), the reflectance increased gradually with increase in φ up to about 70° and then increases rapidly reaching 100% at 90°. Less than 20% of the incident light is reflected for θᵢ<70°.
d. It should be noted that the intensities of the reflected and transmitted light do not add up to the intensity of the incident light. This seems to violate the law of conservation of energy. This apparent violation is actually due to the definition of intensity as energy per unit time per unit area. Because of refraction, the incident and transmitted light do not have the same cross sectional area. If the differences in cross sectional areas are taken into consideration, then it can be shown that the energy per unit time in the reflected and transmitted beams add up to the energy per unit time in the incident beam.

ii. Reflectance for the Case Where the Light Beam Travels from a Medium of High Refractive Index to one of Low Refractive Index (ni>nt).

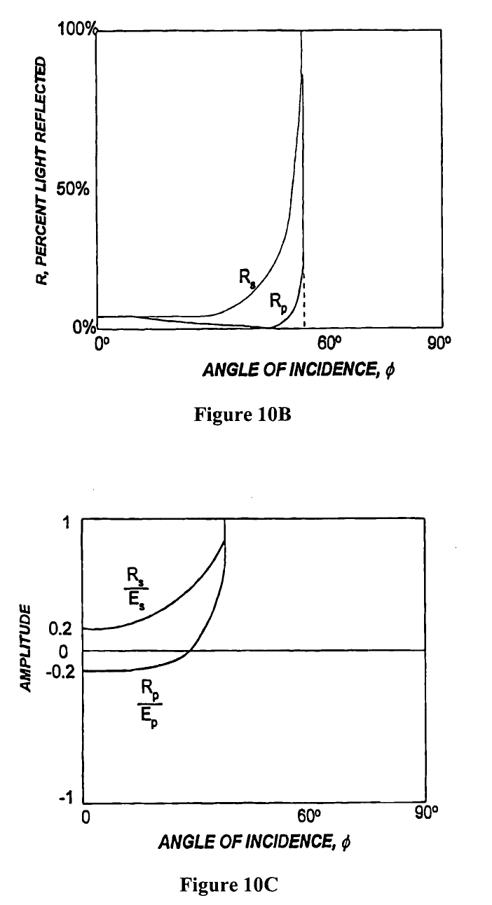

FIG. 10 shows plots of reflectance of polarized light vs. angle of incidence (φ=θᵢ) for nᵢ=1.54 and nₜ=1. The plots are quite different from those of FIG. 9 for which nᵢ<nₜ. The most significant difference is that at an incident angle greater than about 41° all of the light is reflected (100% reflection, total reflection). The smallest incident angle at which total internal reflection occurs is called the critical reflection angle θ_{c}. The value of this angle depends on the values of nᵢ and nₜ. An expression for calculating θ_{c} from values of nᵢ and nₜ can be derived by considering the angles of the incident and transmitted light beams at the critical angle. At the critical angle θ_{c}, the reflected beam contains most of the incident light and makes an angle θ_{c} with the respect to a line perpendicular to the surface as required by the laws for specular reflection. The transmitted light has low intensity and its angle θₜ with respect to perpendicular line is 90°. That is, the transmitted light beam travels parallel to the surface. The value of θ_{c} can therefore be obtained by inserting θₜ=90° in Snell's Law. This insertion yields:
nₜ sin (90°)=nᵢ sin (θ_{c}). (3)

Since sin (90°)=1, then:
sin (θ_{c})=nᵢ/nₜ (4)
For nₜ=1.54 and nᵢ=1 (air), the above equation yields θ_{c}=40.5°. It should be noted that the critical angle is the same for unpolarized light and light polarized perpendicular or parallel to the incident plane. That is, θ_{c} is independent of whether the light is unpolarized or plane polarized.

iii. Effects of Reflectance and Refraction on the Illumination of a Spatially Defined Distribution of Light Scattering Particles

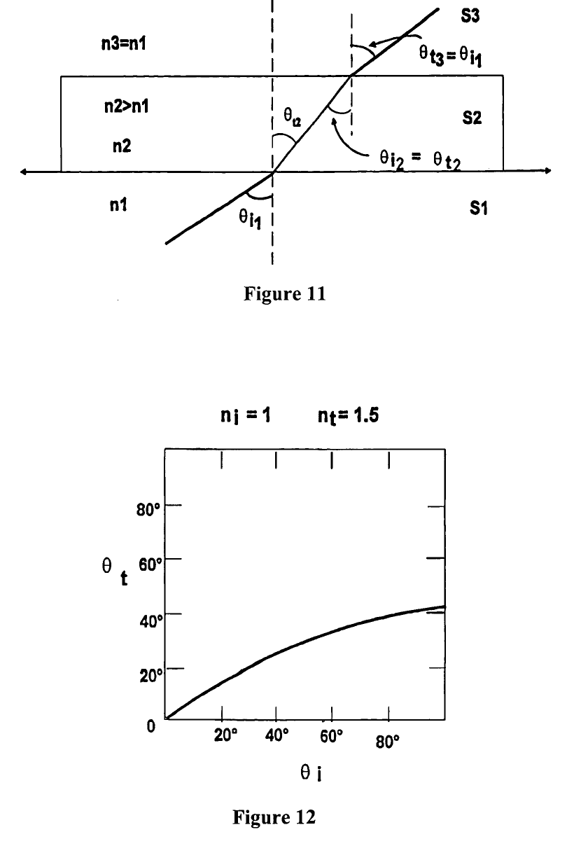

The first case considered is the simplest case of where light scattering particles are on the surface of a dry microscope slide in air. That is, the particles are dry and air is the medium on both sides of the microscope slide. FIG. 11 shows a schematic diagram of the reflections and refractions involved in this case. The first reflection occurs at the surface S1 (nᵢ<nₜ, θᵢ, nᵢ=1 and nₜ=1.5). FIG. 9A shows that the fraction of light reflected is below 20% for incident angles up to 70°. Therefore, light loss due to reflections at interface S1 are not significant in this scheme of illumination. At interface S2 the light beam passes from a high to a low refractive index material, and the possibility exists for total internal reflection at this interface. The critical angle for total internal reflection at a surface where nᵢ=1.5 and nₜ=1 (air) is about 42+ (calculated with Eq. (4)).

FIG. 12 shows a plot of θᵢ2 [θtj] vs. θᵢ1 [θij] calculated with Snell's Law (Eq. (1)) and using θₜ1=θᵢ2. As can be seen from the plot, θᵢ2 rapidly increases with increase in θᵢ1 up to about θᵢ1=70°. The increase in θᵢ2 then levels off and does not reach the critical angle until θᵢ1=90°. However, at θᵢ=90°, no light is transmitted across S1. It can thus be concluded that for the arrangement of FIG. 11, critical illumination is never achieved at any practical angle of θᵢ1. Furthermore, reflections do not significantly diminish the amount of light delivered to the particles on S2 for θᵢ1 values less than about 70°.

### 5.1.2 Illumination and Detection in Planar Waveguide Structures

In various embodiments of the invention, the light scattering particles are illuminated by non-evanescent light coupled into the waveguide and light scattered by the particles is detected by a sensor or observed directly by eye. A general planar waveguide according to an embodiment of the invention, which is a non-limiting example, may be used to illustrate the paths of the illuminating light and the light scattered by light scattering particles in the waveguide.

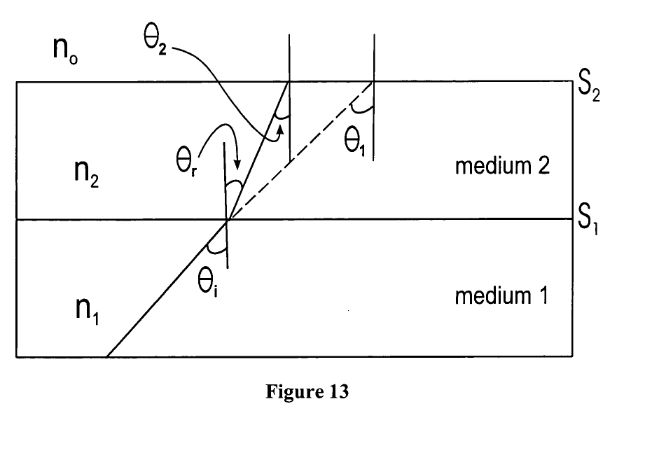

FIG. 13 illustrates a generic waveguide of the invention comprising three different layers, with respective refractive indices of n₁ (layer 1) n₂ (layer 2), and no (uppermost layer 3) where n₀<n₂ and n₂≧n₁. As medium 2 has a refractive index greater than or equal to that of medium 1, then there is no critical angle at the interface of between 1 and 2. If the angle of incidence in medium 1 is θᵢ, and the refracted beam makes angle θᵣ with the perpendicular to the interface S1, then the light will also approach interface S2 with an angle of θᵣ to the perpendicular. FIG. 13 shows the difference in the light path for n₂=n₁ and for n₂>n₁. If n₂=n₁, then θᵣ=θ_{2,} while if n₂>n₁, then θᵣ=θ₁, where θ₁>θ₂. As an example of the possible angles the light beam can make with the perpendicular, if the refractive indices are n₁=1.5 and n₂=1.6, then for an angle of incidence in the range 0°≦θᵢ≦90°, the angle of the refracted beam falls within the range 0°≦θᵣ≦70°.

In a specific embodiment, the uppermost medium is air (i.e., n₀=1), which satisfies the constraint of n₀<n₂. The critical angle for total internal reflection at interface S2 between air and medium 2 is then θ_{c}=sin⁻¹(n₀/n₂)=40°. As the angle θᵣ can range up to 70°, for angles greater than 40° there is the possibility of total internal reflection of the light into medium 2. In a more general sense, if both θ₁ and θ₂ in FIG. 13 are greater than a critical angle θ_{c} at interface S2, then both medium 1 and medium 2 would comprise a waveguide structure for the given values of n₂ and n₁. A waveguide according to the present invention thus preferably comprises two or more layers of material of the same or different refractive indices, or some combination thereof, wherein the refractive index of the medium surrounding the multi-layered waveguide structure (i.e., air or a coating or cladding layer) is chosen to be lower than that of the outermost layers of the waveguide (i.e., layer 2), to maintain total internal reflection of light within the structure. Evanescent light formed at the outermost surface of the waveguide (i.e., interface between waveguide and air/or its cladding) is not used to illuminate the particle labels of the invention.

When scattered light detectable particles are enclosed within one or more of the layers of a waveguide structure of the present invention, then it is the light propagating within the waveguide that illuminates the particles. In an exemplary embodiment of the invention, an assay can be performed on a first material of refractive index n₁, e.g., a glass slide on which the analytes and scattered light detectable particles would be present. When this first layer n₁ is coated with a layer of a second material with refractive index n₂, where n₂≧n₁, and where the second layer completely covers the analytes and particles, then the analytes and the particles would be enclosed in a wave guide. Utilizing all light within the waveguide maximizes the amount of light illuminating the particles, and thus the intensity of the scattered light is increased. This is particularly beneficial for single and multi-analyte assays, where any means of increasing the signal intensity and/or reducing assay background is advantageous. In a specific embodiment where a coating on top of a slide forms the waveguide structure, most of the light passes through the slide-coating interface, and so any light scattering particles present within the coating layer are excited by the photons traveling within the waveguide. It is preferable that the RLS particles are placed in the waveguide structure at a position that allows maximal detection and resolution of the particles within the waveguide. In a specific embodiment the RLS particles are very close to the surface of the waveguide, to allow optimal resolution and differentiation of the signal from the various particles.

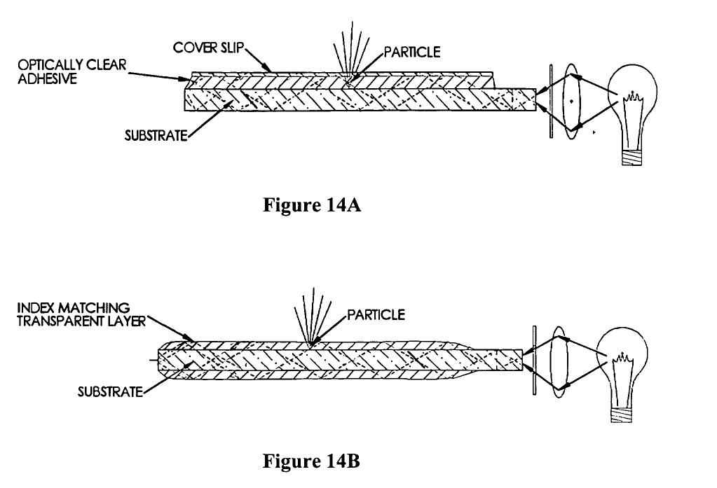

One preferred embodiment of planar waveguide structure 10 according to the present invention is illustrated in FIG. 14A. In this embodiment, clear glass or plastic substrate 12 is used to perform the assay. The assay can comprise, for example, a DNA hybridization event with hapten incorporation or end labeling of the analyte target, a protein sandwich assay, or any other biomolecule labeling event in which metal or non-metal colloidal particles (P) are used as tags. The assay containing surface of substrate 12 is coated with an optically clear adhesive 14 and a thin sheet of transparent polymer or glass cover slip 16 is applied or laminated thereon. The index of refraction of adhesive 14 is preferably the same as that of substrate 12 and cover slip 16. In a preferred alternative embodiment, shown in FIG. 14B, substrate 12 is coated with liquid layer 18 that cures to form a transparent layer with an index of refraction closely matching that of the substrate. Layer 18 may be, for example, a cross-linked or non-cross-linked polymer as described in greater detail below. The cured top and bottom surfaces are preferably glossy, with no imperfections that would scatter light. An exemplary illumination system may include illumination source 20, and optical elements such as collimating optics 22 and stop 24. Instruments for illuminating and viewing/recording samples are described in greater detail below. In a further preferred embodiment, edges of substrate 12 that are not presented to the light source may be coated with a reflective material to minimize loss of light and provide more uniform illumination.

The scattered light detectable particles need not be near the interface formed by the coating layer and the optically transmissive material. The scattered light detectable particles are preferably of a size between 1 and 500 nm inclusive. However, different particle type configurations can be used, as previously described. In a specific embodiment, the scattered light detectable are chosen to be either all spherical in shape; all asymmetrical or symmetric-non-spherical in shape (e.g., cylinders, rods or ellipsoids), with their major axes randomly oriented relative to the interface between the coating layer and the optically transmissive element; or a combination of both spherical and asymmetric or symmetric-non-spherical particles are chosen.

Light can be coupled into a waveguide of the invention using a variety of different methods known in the art. Preferably, the waveguide is illuminated in such a manner that the amount of stray light reaching the detection optics is minimal. In one embodiment, light is coupled into the waveguide by shining the illuminating light directly onto a face of the waveguide. In this embodiment, care is taken to make sure that the entire face of the waveguide is uniformly illuminated. In a preferred embodiment, a specially designed device which may be hand-held is used for coupling light into the waveguide.

In various embodiments, the light is focused onto one or more sides of the waveguide using various optics known in the art, such as a lens. In an alternate embodiment, the edges of the waveguide structure are beveled at an angle, and the illumination source is placed relative to this beveled edge such that much of the light approaches the face of the beveled edge at normal incidence (i.e., at a 90° angle). In this arrangement, the majority of the incident illuminating light is coupled into the waveguide, with minimal scattering. It is preferable that the outer surfaces of the waveguide are smooth, as any roughness will cause loss of light from the waveguide (through refraction of the light). In an alternative embodiment, a surface of the waveguide is coated with a coating that is reflective to visible illumination, which could help to minimize light loss.

One or more optical elements, such as prisms, gratings or input or output couplers, can be used to coupled into or out of the waveguide in different embodiments. In one embodiment, light can be coupled into or out of the waveguide using a prism in close proximity to the surface of the waveguide or a grating surface on a surface of the waveguide. In yet another embodiment, light is coupled into or out of the waveguide using an input grating coupler or an output grating coupler, respectively. In specific embodiments, the input grating coupler and output grating coupler will permit light to be coupled into or out of the waveguide at the same angle or at different angles. In other embodiments, the input coupler and the output coupler are on the same surface of the waveguide, or are on different surfaces of the waveguide.

The detection optics are optimally placed at any position relative to the waveguide surface that maximizes the signal from the RLS particles, and allows differentiation of the signals from individual particles and/or aggregates of particles and/or a population of individual or aggregate particles. The light scattered by the RLS particles is detected by a detector placed above the upper surface of the waveguide or below the upper or lower surface of the waveguide. In a specific embodiment, the detector is placed just above the upper surface of the waveguide, and collects light from the entire surface of the waveguide or from an area of interest at a subsurface of the waveguide. The detector can be either fixed in position relative to the surface of the waveguide which can be moved so that the entire surface of the waveguide can be read or the surface of the waveguide can be fixed relative to a moveable detection device or a combination of both waveguide and detector motion and control.

In specific embodiments, the light scattered by the labels is detected using a human eye under low magnification, or using a microscope or other viewers. Alternatively, the waveguide can be imaged using a CCD camera, an area CCD chip, a CMOS camera or chip, or any appropriately configured photodetector known in the art. In a specific embodiment, the waveguide is scanned by means of a photodetector or photomultiplier tube and a scanning stage. In embodiments where the RLS particles in the waveguide are detected using scanning involving movement of either the waveguide and/or the photodetector relative to one another, the signal of the particles can be linked with the separately addressable sites of an array enclosed within the waveguide. In yet another alternate embodiment, a spectrometer is used to detect the RLS particles.

### 5.1.3 Materials of the Waveguide

The waveguide of the present invention comprises two or more layers of optically transmissive materials with the same or different values of refractive indices. The restrictions on the relative refractive indices of the layers of the waveguide of the invention have already been described. As such, any material that satisfies these constraints could be used to form the waveguide. In a preferred embodiment, the refractive index of the layer of the waveguide that contains the RLS particles is higher than the refractive index of the two layers on either side (i.e., n₂>n₁ and/or n₂>n₀). This satisfies the previously described restrictions on the refractive indices and therefore ensures that non-evanescent wave light illuminates the particles. However, there are other considerations such as the compatibility of the materials of different layers and also the compatibility of the methods used to deposit or coat the different layers. In a specific embodiment, one or more of the layer of the waveguide undergo a curing or drying process in order to form the waveguide. Depending on the material used, the refractive index of the coating layer that comprises the particles can initially be less than those of the neighboring optically transmissive layer before the completion of the curing or drying process, but becomes greater than or equal to that of the optically transmissive layers after completion of the curing or drying process.

In each layer of the waveguide, the optically transmissive material can each separately comprise minerals, glass, an optical polymer, and/or an optically clear hybrid inorganic/organic coating. Many examples of such materials are known in the art including but not limited to silicon dioxide (e.g., quartz), silica, borosilicate, barium silicate, calcium fluoride, magnesium fluoride, a polystyrene, a polycarbonate (e.g., Lexan®), a polyvinyl chloride, a polyvinyl alcohol (PVA), a polyethylene, a polytetrafluroethylene (PTFE, e.g., Teflon®), a perfluroalkoxy (PFA, e.g., Teflon®), polyvinylidene fluoride (PVDF, e.g., Ardel(®), an acrylic (also acrylate, a polymer or copolymer of derivatives of acrylic acid; e.g., Lucite®, Plexiglass®, OptoGuide®), a polyurethane, beta-pinene, a polyolefin, a cyclic olefin (e.g., Topas®, Zeonor®), cellulose acetate butyrate (e.g., Tenite®), benocyclobutene (e.g., Cyclotene®), a polysulfone (e.g., Udel®), a polyester (e.g., Mylar®), a polyimide (e.g., Kapton®), a siloxane, an epoxide, an organometallic compound, a metal oxide or a silicon oxide. For a more complete description, see S. Musikant, “Optical Materials”, Marcel Dekker, Inc., New York 1985, and Marvin J. Weber, “CRC Handbook of Optical Materials”, 2002; which are incorporated herein by reference in their entirety.

As a non-limiting example, PVA is used to coat a first optically transmissive material, such as glass, to form a waveguide. PVA is a water-soluble resin produced by the hydrolysis of polyvinylacetate which is made by the polymerization of vinyl acetate monomer. A variety of PVA having different degree of hydrolysis and degree of polymerization can be used. The refractive index of PVA aqueous solution depends on concentration and temperature, and can be determined and adjusted by one of skill in the art according to the refractive index of the other optically transmissive material of the waveguide. On drying, the refractive index of PVA can change to a value that is equal to or higher than that of the other optically transmissive material.

Other film-forming ingredients can also be incorporated into the formulation to enhance properties such as film toughness or wet adhesion. In a specific embodiment, the layer materials are highly crosslinked, which can result in high scratch resistance. The materials may provide a desirably higher refractive index (at least about 1.49-1.51, depending on the formulation ratios), and toughness or resiliency of the hard coating film, as well as water resistant adhesion. In exemplary embodiments, the coating is thermally cured, or cured by applying UV radiation or combined UV/IR radiation. In an alternate embodiment, a UV curing agent, such as aryl ketones photoinitiators, may be incorporated into the formulation. UV radiation then promotes the polymerization, and hardening of the material.

U.S. Pat. No. 5,856,018 describes the production of titanium- or silicon-containing organically-derived materials that are suitable for application as layering materials of the waveguides of the present invention. The titanium-comprising material is produced by mixing a titanium alkoxide such as titanium isopropoxide, titanium propoxide, or titanium ethoxide with ethyl alcohol, deionized water, and an acidic catalyst such as hydrochloric acid or nitric acid. The material comprising silicon is produced by mixing a silicon alkoxide such as tetraethyl orthosilicate or tetramethyl orthosilicate, ethyl alcohol, deionized water, and an acidic catalyst such as hydrochloric acid or nitric acid. The cured materials comprise polymerized, solid layers of titanium dioxide and silicon dioxide. The titanium dioxide layers have refractive indices in the range of 1.80 to 2.20, and the silicon dioxide layers have refractive indices in the range of 1.40 to 1.46.

In the field of optics, semiconductor device fabrication, and telecommunications, fairly low temperature coating techniques have also been developed for creating waveguide structures, and for protection and passivation of electronic circuitry. These techniques can be exploited to deposit thin films of materials with different compositions, and as a result, different refractive indices, such as dielectric compounds of silicon (including, but not limited to oxides, nitrides, oxynitrides, and carbides), various metal oxides, nitrides and carbides or other dielectrics compounds comprising metals such as tantalum, titanium, indium, tin, gallium, indium, etc., or mixed composition metal oxides, such as zinc indium tin oxide, gallium indium tin oxide, etc., as non-limiting examples. These techniques are generally conducted in evacuated chamber into which different desired gaseous mixture are introduced at sub-atmospheric pressures. This helps to insure that there is minimal or preferably no contamination of the surface (comprising the light scattering particles and the analyte of interest) during the coating process. Additionally, many of these deposition techniques are performed at fairly low temperatures (<200° C.) and some may even be performed at or slightly above room temperature.

In the technique of sputter deposition, or reactive sputter deposition, the surface on which the film is to be deposited is placed on an electrode, while, e.g., the silicon or metal forms the opposite electrode (called a target) inside a vacuum chamber. Although one electrode configuration has been described, other electrode configurations may be used, including triodes, etc. An inert or reactive gaseous mixture is introduced into the chamber, an electric field is generated, ion bombardment of a target electrode results in the deposition of the thin film. Gaseous mixtures include, but are not limited to, argon, oxygen, nitrogen, ammonia, carbon dioxide, nitrous oxide, etc. In the related technique of plasma-enhanced chemical vapor deposition, there is no target, and all of the elements that comprise the desired film are introduced as gases and vapors. During an evaporation process, a solid material is heated to a temperature high enough to liberate ions, which then incorporate with the gaseous mixture present in the atmosphere of the chamber to deposit a dielectric film.

The refractive index of each material can be the same for all wavelengths of light in the visible region of the spectrum or it can vary with wavelength. The refractive index of tantalum oxide decreases monotonically from 2.4 at a wavelength of 300 nm to about 2.1 at a wavelength of 500 nm, but remains near a value of 2.1 for wavelengths from 500 nm to 800 nm. In contrast, for a material like quartz, the refractive index can vary little from the value of n=1.55 over the entire visible spectrum.

TABLE 1
Table Of Refractive Indices

| | Refractive index (visible wavelengths, |
|---|---|
| Composition | room temperature) |
| Titanium dioxide | 2.55-2.73 |
| Antimony oxide | 2.09-2.29 |
| Zinc oxide | 2.02 |
| Silica | 1.41-1.49 |
| Quartz | 1.55 |
| Silicon oxynitride | 1.51 |
| Silicon nitride | 2.1 |
| Polystyrene | 1.60 |
| Polycarbonate | 1.59 |
| Polyethylene | 1.50-1.54 |
| Acrylic | 1.49 |
| Polyvinyl chloride | 1.48 |
| Polyvinyl alcohol | 1.52-1.55 |

### 5.1.4 Method of Refractive Index Enhancement

The use of refractive index enhancement in telecommunications and other related fields is well known in the art. This technique is generally used to decrease the nonspecific light scattering and reflections that occur as a light beam passes from one medium or device to the other as for example, from the surface of one medium to the surface of a different medium. The technique of refractive index matching introduces another tunable parameter in choosing the refractive index for formation of a waveguide structure.

The present invention provides a method for improving the ability of a detection system to distinguish between background and a specific signal. In the context of analyte detection systems, the specific signal is signal associated with the specific analyte. Such enhancement can involve relative or absolute reduction in background signal and/or relative or absolute increase in specific signal.

In yet another aspect, the invention provides a method for enhancing specific detection of light scattering particle labels in an analyte assay, by coating at least a portion of a sample device having attached light scattering particle labels with an optically clear, solidifying solution, where the solid coating resulting from the coating provides refractive index enhancement for the scattered light signal from the particles.

It has been determined that the light scattering power (Csca) of a specific type of particle is affected by the medium in which the particle resides. Altering the refractive index of the medium results in a change in a particle's light scattering properties.

The refractive index of the bathing medium has interesting and useful effects for RLS particle applications. For dielectric particles such as glass (silica gel particles) or polystyrene, that have a real refractive index, a plot of scattered light intensity Iₛ vs n_{med} displays a minimum at n_{med}=nₚ. This result is consistent with Rayleigh's equation which shows that Iₛ=0 when m=nₚ/n_{med}=1. The disappearance of light scattering when nₚ=n_{med} is usually said to be the result of index matching. On the other hand, for particles such as gold and silver particles, which have a complex refractive index, Iₛ vs n_{med} does not show a minimum, but increases continuously with increase in n_{med} beginning with n_{med=}1. That is, increase in medium refractive index increase the brightness of a gold or silver particle. In addition the scattered light color shifts towards the red. The different effects which medium refractive index has on dielectric and silver and gold particles can be used to reduce background scattering in the waveguides comprising RLS particles and the results of, e.g., solid phase assays. Addition of a high refractive index bathing medium or coating material to a glass microarray labeled with RLS particles decreases background scattered light intensity from, for example, dust particles and scratches on the glass surface and increase scattered light intensity from the RLS particles. Similarly, in tissue samples labeled with RLS particles, a high refractive index bathing medium or coating material decreases the high light scattering background produced by the tissue and increases the intensity of the RLS particles. Refractive index matching also makes it possible to use RLS particles for detection of, for example, dot blots on nitrocellulose membranes, wherein treatment of the membrane with an appropriately formulated reagent that matches the refractive index of the bulk membrane renders the membrane, a highly scattering matrix a priori, clear and transparent.

Table 2 provides an illustrative example of medium refractive index effects on selected particles. Calculated refractive index medium effects for gold, silver, and polystyrene spherical particles of 10 nm diameter are presented.

The effects of the refractive index of the medium are quite different for metal-like particles as compared to non-metal-like particles. Table 2 shows the effect of the refractive index of the medium on the relative scattering power and wavelength of maximum scattering for 10 nm gold, silver and polystyrene particles. Increasing the refractive index of the medium for metal-like particles as for example gold, results in increasing the intensity and wavelength maximum of the light scattered from the particle while for a non-metal-like particle, as for example polystyrene, the light scattering power is decreased. As indicated in column (A), the scattered light from polystyrene diminishes to zero when the refractive index of the bathing medium approaches that of polystyrene (i.e., n=1.6).

The unique light scattering properties of metal-like particles as compared to non-metal-like particles as an effect of the refractive index of the sample medium can be used to more specifically and with greater sensitivity detect metal-like particles in samples including those which have high non-specific light scattering backgrounds. This is important for many different types of diagnostic analytical assays.

TABLE 2
Calculated Medium Refractive Index Effects For 10 nm Particles

| | | |
|---|---|---|
| GOLD | SILVER | POLYSTYRENE |

| N₁ | (A) | (B) | (A) | (B) | (A) | (B) |
|---|---|---|---|---|---|---|
| 1 | 1 | 520 nm | 1 | 355 nm | 1 | 400 nm |
| 1.1 | 1.9 | 525 nm | 1.6 | 360 nm | 0.9 | 400 nm |
| 1.2 | 3.9 | 525 nm | 2.3 | 370 nm | 0.75 | 400 nm |
| 1.3 | 7.7 | 530 nm | 2.9 | 380 nm | 0.52 | 400 nm |
| 1.4 | 15.1 | 535 nm | 3.9 | 390 nm | 0.27 | 400 nm |
| 1.5 | 27.7 | 540 nm | 5.3 | 400 nm | 0.084 | 400 nm |
| 1.6 | 45.4 | 550 nm | 7.3 | 415 nm | ˜0 | — |
| 1.7 | 71.5 | 555 nm | 9.7 | 425 nm | 0.1 | 400 nm |

(A) = Relative scattering power at different medium refractive indices
(B) = Wavelength at which scattering maximum occurs
N₁ = refractive index of medium

### 5.1.5 Formation of the Waveguide

A multi-layered waveguide of the invention could be formed from any combination of optically transmissive materials that satisfy the relationships previously described for the refractive indices of the layers. Table 1 gives an exemplary list of values of refractive indices for different candidate waveguide materials. Other constraints include, but are not limited to, the compatibility of the materials of each layer material and the deposition processes used.

In preferred embodiments, the particles are located in a layer of optically transmissive material that has a refractive index which is higher than that of a layer with which it forms an interface.

A multi-layered waveguide structure can be formed from the sequential layering of polymeric material through a dipping and drying process or a coating process. As an exemplary formation of a waveguide, an assay involving RLS particles and analytes of interest is performed on an optically transmissive substrate comprising silica (n=1.41-1.49) which forms the first layer. RLS particles and the analytes deposited on one or more surfaces of the substrate is dipped in or coated with an acrylic composition (n >1.49) to form a second layer, wherein the RLS particles and the analytes are present at the interface of the two layers. This exemplary structure satisfies the condition that the refractive index of the layer containing the particles has refractive index greater than or equal to that of the layer below it (the silica), and greater than that of the layer above it (in a specific embodiment, air). A two or three layered waveguide structure can result, depending on how the silica is dipped in or coated with the acrylic composition. Application of the coating agent layer or layers can be accomplished by any one or more methods including, but not limited to, dipping, aerosol spraying, vapor deposition and atomization of the agent. A precursor of the second optically transmissive layer, which is in liquid phase or gaseous phase, can be applied to the first layer on which the particles are distributed or deposited. Additionally, the particles could be distributed in the second layer of the waveguide. The formation of the second layer could involve a curing process. Examples of coating include those that comprise a polyvinyl alcohol, a polyurethane, or beta-pinene.

In an alternative embodiment, the silica substrate comprising one or more RLS particles and the analyte of interest are dipped in or coated with a hybrid organic/inorganic coatings (n=1.49-1.51), which is then thermally cured or cured using ultraviolet (UV) radiation or combined ultraviolet/infrared (UV/IR) radiation. In a specific embodiment, a UV curing agent is added. In an alternate embodiment, the waveguide structure comprises two, three, four or more layers of materials, wherein two or more layers have the same refractive indices, or different refractive indices, or mixtures of the same or different refractive indices.

### 5.2 INSTRUMENTATION FOR USE WITH WAVEGUIDES

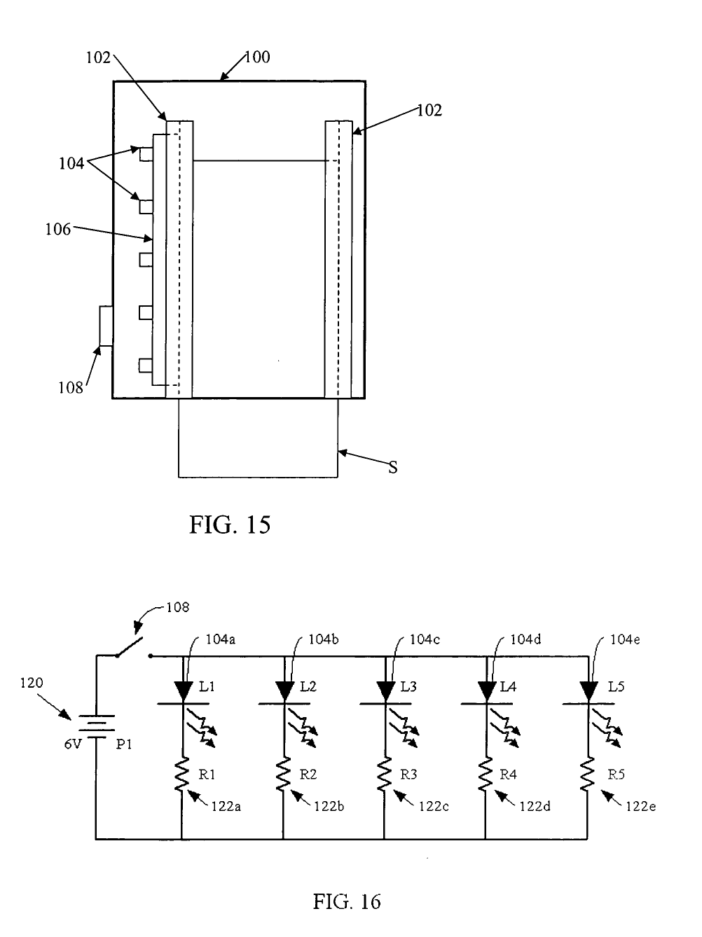

Using a planar waveguide structure according to embodiments of the present invention as described above permits the use of less complex devices for viewing and analyzing samples. For example, as shown in FIG. 15, an illustrative handheld device according to one embodiment of the invention includes housing 100 in which sample supporting rails 102 are mounted. Rails 102 are configured and dimensioned to slidingly receive a slide (S) or other substrate prepared as a waveguide as described above. LEDs 104 are mounted along the outside of one rail 102. The LEDs are mounted to optically communicate with an edge of slide (S) through rod-shaped lens 106. Rod shaped lens 106 is positioned with its longitudinal axis along an edge of the slide and thus arranges the light from the LEDs in at least a substantially straight line prior to the light entering the waveguide. Lens 106 is positioned with respect to the rail 102 to provide an efficient optical coupling with a slide when inserted. The optical coupling may arise through direct contact between the slide and lens or through an appropriately sized air gap. The angle of the light delivered into the slide is preferably greater than the critical angle in relation to the labeled surface to create total internal reflection. The critical angle is determined by means of the comparative index of refraction of the two materials, one of which being air. The light wave propagates through the substrate and continues across the substrate-coating interface and is reflected back at the same angle. Since all the light passes through the substrate-coating interface, the label is excited by all the photons traveling within the waveguide. LEDs 106 may be activated by holding down button 108. Preferably power to the LEDs is cut off automatically when the button is released to conserve power.

An exemplary circuit is illustrated in FIG. 16. In this circuit, six volt battery 120 drives LEDs 104a-e, connected in parallel. Resistors 122a-e are connected in series, respectively, with each LED. As an example only, the LEDs may be Gelcore™ part number GEWM54ROY5-CCB2. Resistors 122a-e may be 22 ohm, 0.5 watt resistors. While five LEDs are illustrated in FIGS. 15 and 16, it will be appreciated that any appropriate number may be selected based on factors such as LED brightness and the length of the typical slide to be viewed.

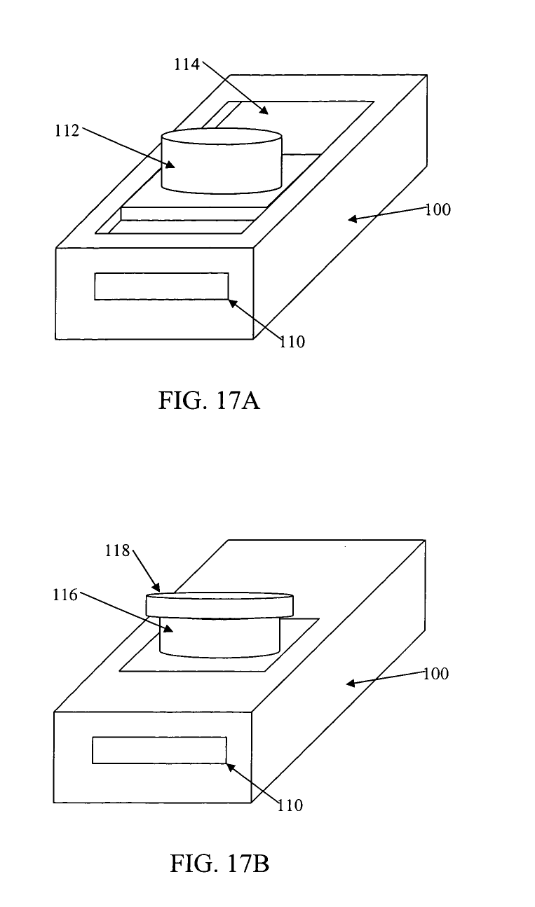

Referring to FIG. 17A, samples on slide (S) may be viewed through eyepiece 112. Persons skilled in the art may select a lens for the eyepiece that provides magnification suitable for a particular application. Generally magnifications in the range of about 3× to about 12× should be sufficient, e.g., about ×5 to about ×10, or about ×7 to about ×8, with about 6× and about 9× being particularly useful powers. Of course, others may be selected and interchangeable eyepieces may be provided at different powers. In this embodiment, slide (S) is inserted through opening 110 and received in rails 102 as described above. When illuminated by depressing button 108, different portions of the slide may be viewed by moving eyepiece 112 back and forth along tracks in eyepiece opening 114. Alternatively, as shown in FIG. 17B, eyepiece 116 may be fixed and different sections of the slide viewed by moving the slide back and forth through opening 110.

In a further alternative feature of the invention shown in FIG. 17B, recorded images of the slide may be made by attaching an imaging device to the eyepiece. For example, cuff 118 may be configured and dimensioned to mate with the lens of a digital camera to provide a secure structural and light-tight fitting. Examples of suitable imaging devices include conventional photographic film scanning devices. Using such imaging devices, images may be transferred using conventional techniques to a computer, for example a laptop computer, for further analysis.

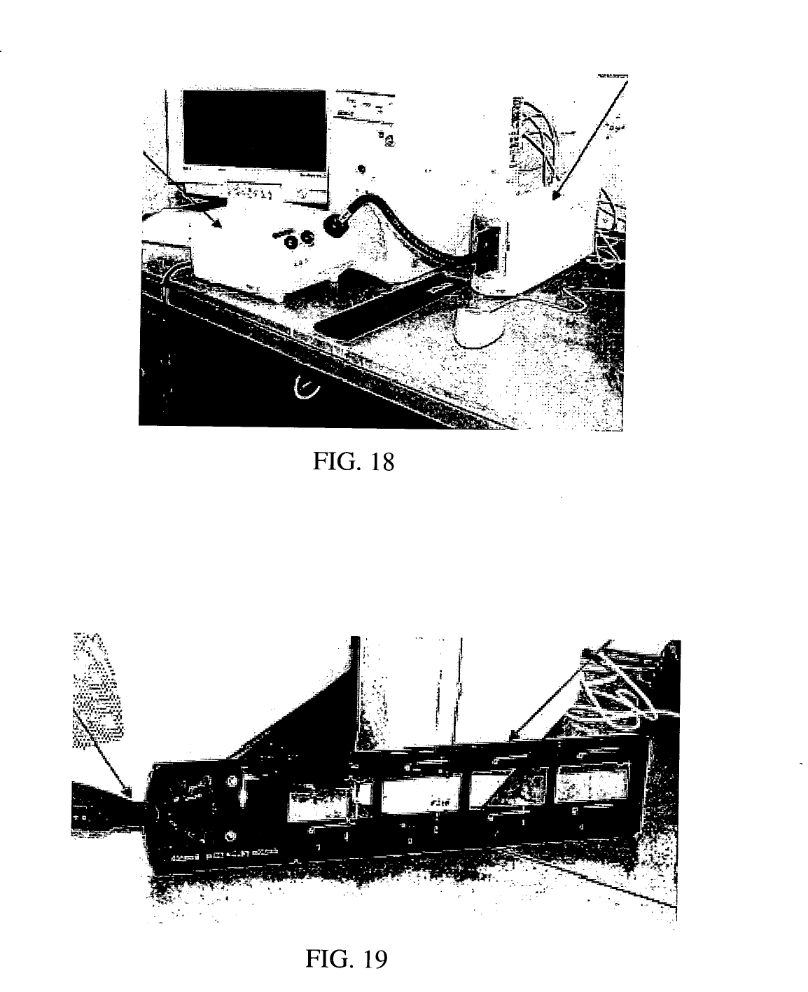

A still simple, but slightly more complex device is a scanner based device as shown in FIGS. 18 and 19. This embodiment is based on conventional photographic film scanning devices, such as the Cannon CanoScan FS 4000US™. In one illustrative embodiment, scanner 130 receives light from light source 132 through fiber optic cable 134. Slide holder 136 is modified to support the end of cable 134 adjacent a slide receiving location 138. Clips 140 or other suitable means may be used to secure the slide on slide holder 138. In one preferred embodiment, the optical coupling between cable 134 and the slide is achieved by suitable finishing of the cable end and an appropriately sized air gap. In a preferred arrangement the slide is arranged such that the light enters the waveguide at one end, as illustrated in FIG. 19. Scattered light from particles bound to the sample is then received by the scanner detection system in the conventional manner. A digital image is created by the scanner software and communicated to an attached processing unit 140, such as a conventional PC.

Slide holder 136 may be configured to hold multiple slides. For example, slides may be positioned end to end on the holder with a suitable optical coupling between each. In a more preferred embodiment, optical splitter 142 splits cable 134 into multiple cables, each one having an end positioned to illuminate one slide. The slides may still be positioned end to end or arranged in any other way that is compatible with the scanning device used.

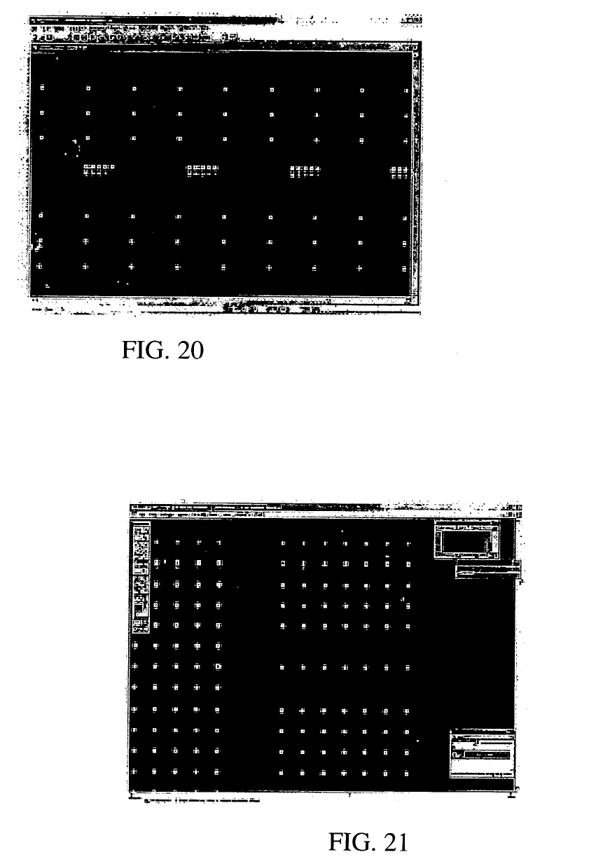

The following illustrative example describes the modification and testing of a Cannon CanoScan FS 4000US™ scanner according to an embodiment of the present invention. In this example, the scanner was modified as shown in FIGS. 18 and 19 to accept a one inch by three inch sample slide with a waveguide formed thereon as previously described. The scanner internal light source was blocked with a small piece of black felt. Clips 140 where added to the existing slide holder 136 to hold the sample slide. The end of the fiber optic cable was configured to form a thin plane of light and hold down bracket 144 for the cable was mounted on the slide holder. A Schott light source 132 was used to illuminate the fiber optic cable. After setup was complete, a polyurethane archived gold calibration slide was imaged in the scanner's 4,000×4,000 dpi mode (highest scanner resolution). The scanning took approximately eight minutes. The image was saved to the attached PC 140 via USB connection in TIFF format and viewed on an attached computer monitor. Visual appearance was found to be acceptable as features down to 0.003 Au particles/μm were visible. The results are represented in FIG. 20. In a second test, a two-color slide was imaged in 42-bit color mode. This image was viewed with Adobe PhotoShop™ and is represented in FIG. 21. In the color image, the gold and silver features were visually differentiable.

### 5.3 RESONANCE LIGHT SCATTERING PARTICLE LABELS

The following description provides a theoretical basis for signal generation and detection that are based on resonance light scattering particle labels and helps to illustrate the claimed invention. The formulae given below are useful in practice and optimization of the present invention, and in defining light scattering particles by its various properties, but are not admitted to be prior art to the claims.

Resonance light scattering (RLS) provide a highly sensitive method for detecting the presence of analytes associated with submicroscopic particles. Preferably the particles are gold and/or silver particles of uniform dimensions, typically in the range of 40-120 nm in diameter, though particles in a greater range can also be used, e.g., 1-500 nm, or 20-200 nm, or 30-300 nm. When illuminated with white or other polychromatic light under appropriate conditions, these particles scatter light of a specific color and intensity, with very high efficiency. The dimensions of the particles need not be identical but are preferably within a narrow range such that scattered light of a consistent and characteristic color is produced. The particles can be derivatized with a variety of biomolecules to allow specific particle binding for detection and potentially quantitation of many different target moieties, for example, haptens, antigens, proteins, peptides, carbohydrates, lipids, small molecule ligands, nucleic acids, and the like. RLS detection systems also provide excellent spatial resolution for applications requiring precise microscopic localization. Such RLS particles are extremely useful as labels in a variety of analyte assays and are preferred in the methods of the invention. The RLS particles are preferably a size between 1 and 500 nm inclusive, and have properties such that light scattered from one or more of the particles can be detected by a human eye with less than 500 times magnification and without electronic amplification.

The optical properties of resonance light scattering (RLS) particles depend on the particle composition, size and shape and the refractive index of the bathing medium. The preferred label compositions and sizes are those which display a strong light scattering band in the visible region of the electromagnetic spectrum (for visual detection applications). The particle compositions and sizes desired for ultra-sensitive detection can be estimated by examination of light scattering theory, especially as expressed by Rayleigh's theory of light scattering. The Rayleigh expression applies to spherical, homogeneous particles that are much smaller than the wavelength of incident light (radius less than about 1/10 of the incident light wavelength). Although some of the particles that are used have diameters that are larger than the Rayleigh size range, the Rayleigh equation nevertheless provides the basic guidance for selection of particles that are best suited for use as ultra-sensitive labels. Before examining the Rayleigh expressions, it is advantageous to understand the mechanism of light scattering which are presented in the following paragraphs.

### 5.3.1 Mechanism for Light Scattering

When a small particle is illuminated with a beam of monochromatic polarized light (i.e., consisting of electromagnetic waves oscillating in a given direction), an oscillating electric force is exerted on the electrons in the particles. The electrons respond through oscillating in the polarization direction (here taken to be the vertical direction) with the same frequency as the incident light. If the particle is much smaller than the wavelength of the incident light, then all of the electrons in the particle oscillate collectively in phase with the light wave thus producing a large oscillating electric dipole moment. It is known from electrodynamic theory that such an oscillating dipole radiates electromagnetic waves that have the same frequency and wavelength as the driving incident wave. It is this radiation that constitutes the scattered light. It should be stressed that when illuminated with monochromatic light, all particles scatter light at the same wavelength as the incident light, independent of particle size, composition or shape. The light scattering detectable particles can also be configured to display different optical properties, e.g., different colors, under white light illumination as discussed in more detail below.

### 5.3.2 Theoretical Expression for Light Scattering Spectra

The Rayleigh equation for small particle scattering can be written as follows for the case where the incident light is polarized along the vertical direction:

$${I}_{s} = \frac{16 {π}^{4} {a}^{6} {n}_{med}^{4}}{{r}^{2} {λ}_{0}^{4}} \vert \frac{{m}^{2} - 1}{{m}^{2} + 2} \vert {sin}^{2} α \qquad ( 5 )$$

where Iₛ is scattered light intensity, a is particle radius, λ₀ is wavelength of incident light as measured in a vacuum (the wavelength measured by a spectrophotometer is the wavelength in air which, for practical purposes, is the same as the wavelength in a vacuum), and n_{med} is the refractive index of the medium bathing the particle (λ=λ₀/n_{med} gives the wavelength of the incident light inside of the bathing medium which is the wavelength sensed by the particle). The n_{med} term adjusts l₀ to the wavelength l actually sensed by the particle), α is the angle between the vertical direction of polarization of the incident light and the direction in which the scattering light is detected, r is the distance between the particle and detector, nₚ is refractive index of the particle and m=nₚ/n_{med} is the relative refractive index of the particle. The refractive index of the particle depends on particle composition and wavelength and has substantially the same spectrum (nₚ vs λ₀) as the refractive index of the bulk material. The refractive index at different wavelengths for many materials can be found in various handbooks and scientific articles, for example, in the WinTable 1.5 database compiled by the National Institute of Standards and Technology (Standard Reference Data Program, Gaithersburg, Md. 20899) which is incorporated herein by reference in its entirety.

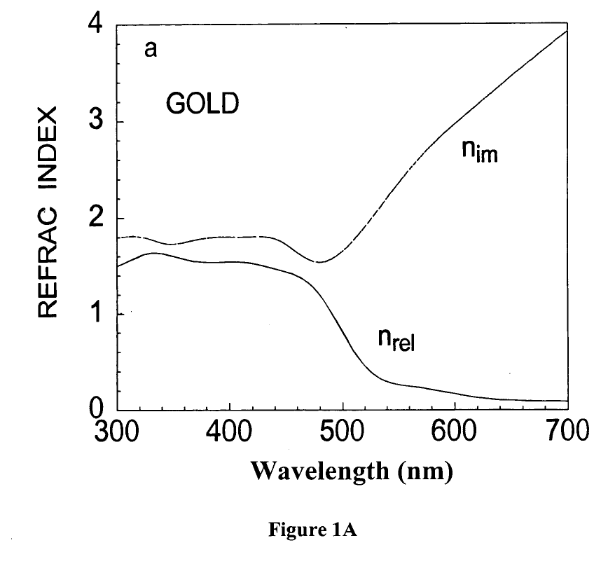

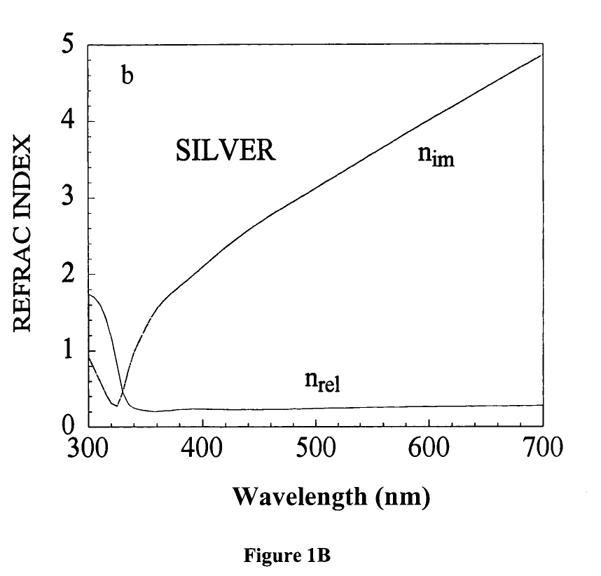

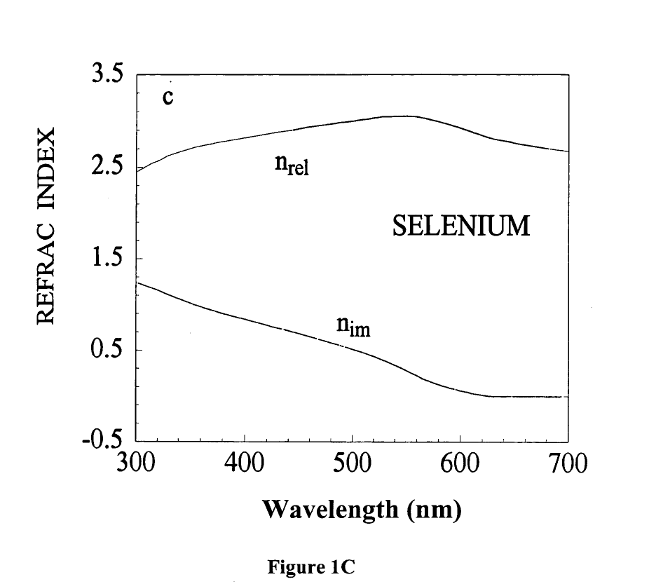

The following statements can be made from Rayleigh's equation concerning light scattering properties that are important for the use of RLS particles as ultra-sensitive labels.
1. Scattered light intensity increases very rapidly with increase in particle size. More precisely, it increases with the sixth power of the radius. Thus an 80 nm spherical particle scatters light approximately 64 times more intensely than a 40 nm particle of the same composition.
2. The effect of composition on scattered light intensity resides in the term containing the value of m, which is the only parameter in Eq.(5) that depend on composition. To explain how m affects light scattering it is necessary to understand that the Maxwell theory of electrodynamics, on which Rayleigh's equation is based, can account for light absorption only by introducing the concept that refractive index can be a complex number quantity. That is, for materials that absorb light (e.g., display a color in the visible region of the electromagnetic spectrum) the refractive index is a complex number. For materials that are transparent and do not absorb light, the refractive index is a real number. Thus, in general the refractive index nₚ of a particle can be expressed as
   nₚ=nᵣₑₗ+inᵢₘ (6)
   where i=√\overline{−1} and nᵣₑₗ and nᵢₘ are, respectively, the real and imaginary components of the refractive index. FIGS. 1A, 1B and 1C shows plots of mᵣₑₗ and nᵢₘ vs λ₀ for gold, silver and selenium, respectively. Both nᵣₑₗ and nᵢₘ depend strongly on wavelength for these materials. For dielectric materials transparent to visible light, such as glass and polystyrene, nᵢₘ is zero and nᵣₑₗ usually does not depend strongly on wavelength. For glass nᵣₑₗ=1.46 (fused quartz) and for polystryrene nᵣₑₗ=1.57-1.60 (depending on the grade). The refractive indices of glass and polystyrene are practically wavelength independent across the visible light wavelengths.

Examination of Rayleigh's equation shows that intense light scattering occurs when the denominator of Eq. (5) is zero, in which case Iₛ becomes infinitely large. Thus the condition for strong light scattering is that m²+2=0. Solving the latter equation for m gives m=i√\overline{2} where i=√\overline{−1}. This result indicates that very strong light scattering occurs at any wavelength where the real component of the relative refractive index is zero (i.e., mᵣₑₗ=nᵣₑₗ/n_{med}=0) and the imaginary component is equal to √\overline{2} (i.e., mᵢₘ=nᵢₘ/n_{med}=√\overline{2}). For transparent dielectric materials, these conditions cannot be met because for them nᵢₘ=0. Therefore particles composed of, for example, glass and polystyrene are not expected to exhibit strong light scattering signals. However, materials such as metals, metal oxides and semiconductors have complex refractive indices that depend strongly on wavelength and thus have the potential for high light scattering intensity by meeting the strong light scattering condition at some wavelength. These conditions do not have to be met exactly but, the closer they are satisfied, the stronger is the light scattering band.

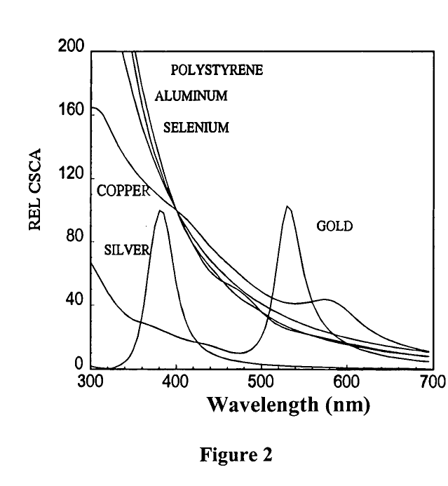

FIG. 2 shows the normalized light scattering spectra of 40 nm spherical particles of different compositions, in water, which is calculated using Rayleigh's equation. For glass and polystyrene particles nₚ is practically independent of wavelength and Iₛ vs λ₀ decreases monotonically with increasing wavelength according to I/λ⁴ as expected from the Rayleigh equation. On the other hand, metal particles can exhibit strong light scattering bands at wavelengths in the visible region due to their complex refractive indices, a phenomenon also known as surface plasmon resonance. Generally, particles that exhibit a strong light scattering band that falls within the wavelengths of about 350 to about 850 nm, about 350 to about 450 nm, about 400 to about 500 nm, about 450 to about 550 nm, about 530 to about 640 nm and about 600 to about 850 nm are preferred. Gold and silver particles exhibit this surface plasmon resonance in the visible region of the electromagnetic spectrum, and hence can appear in different colors. These bands are illustrated in the graphs of FIG. 2, which show that the conditions for high light scattering are approximately satisfied at 525 nm for the 40 nm gold particles and 380 nm for the 40 nm silver particles. Although selenium has a wavelength dependent complex refractive index, the conditions for strong light scattering are not met at any wavelength in the visible region and 40 nm selenium particles do not display a light scattering band in the visible region.

### 5.3.3 Particles Comparable to the Wavelength of Incident Light

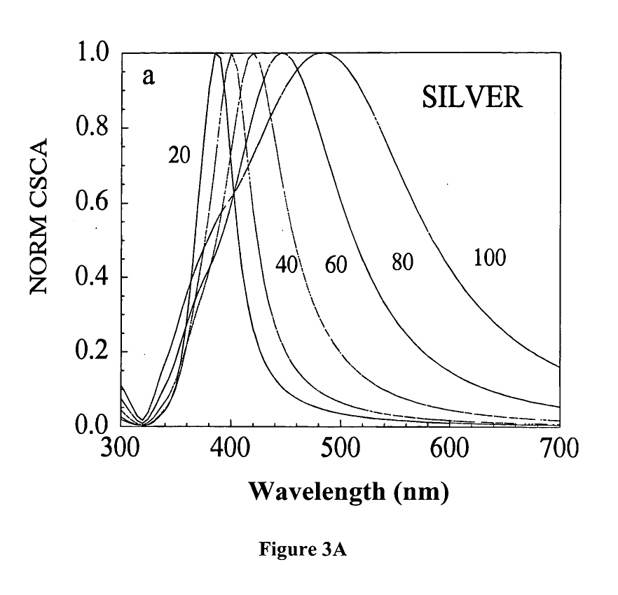

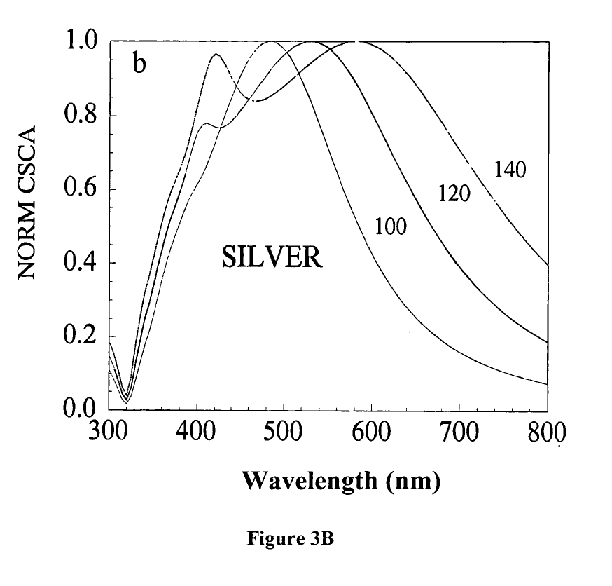

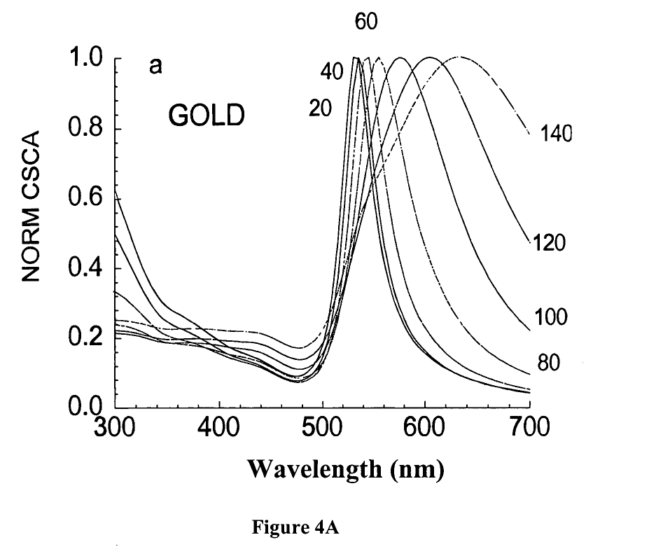

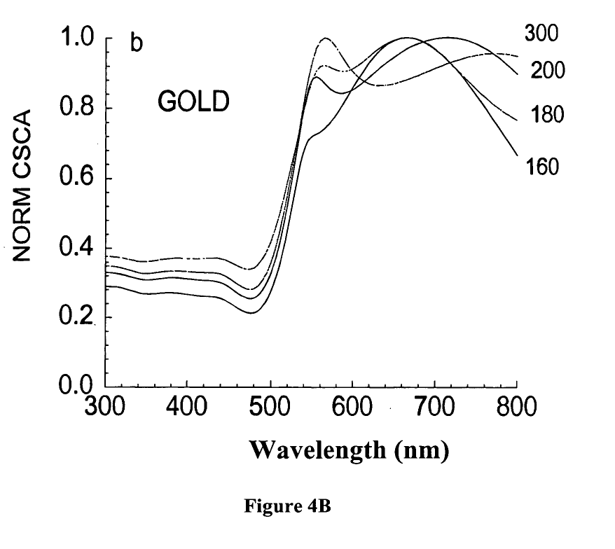

The light scattering and absorption properties of particles with diameters that are comparable to the wavelength of incident light cannot be adequately explained using Rayleigh theory but can be predicted by Mie theory. FIGS. 3A, 3B, 4A and 4B show light scattering spectra of different size silver and gold particles calculated with Mie theory. One of the main changes in light scattering properties that occur in the large particle range is that the color of the scattered light changes with increasing particle size because the light scattering band shifts towards higher wavelengths with increase in particle size. In the small particle range, scattered light intensity increases with particle radius but the shape and wavelength maximum of the light scattering and absorption bands do not change with increase in particle size, as all of the electrons in the particle oscillate with the same phase and give rise to a large oscillating dipole moment. For large particles (diameter greater than about 40 nm), the electrons in different parts of the particle oscillate with different phases since they sense different phases of the incident light wave. Light waves scattered from different regions of the particle have different phases and thus interfere at the surface of the particle, resulting in changes in scattered light spectrum as particle size is increased.

### 5.3.4 Particle Type Configuration For Analyte Assays

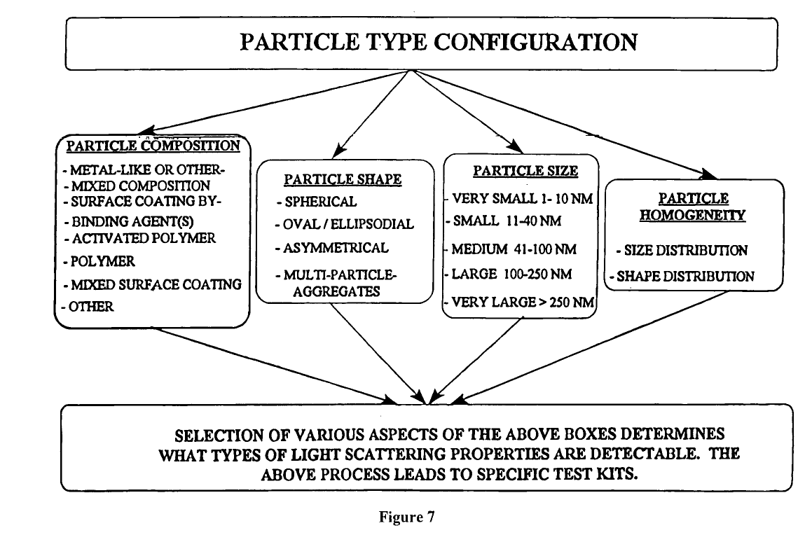

One skilled in the art can use the methods of the present invention to evaluate, modify, and adjust specific particle parameters of composition, size, shape, and homogeneity to derive (i.e., configure) one or more desirable light scattering properties that are easily detected and measured (see FIG. 7). Considerations need to be made with regard to sample types, diagnostic formats, and limitations of apparatus illumination and detection means in the choice of particles. For example, in one application, multi-analyte detection may be performed on a solid-phase sample that contains a high non-specific light background on a high throughput testing apparatus, while in another application, single analyte detection in solution is performed in a point of care assay in a doctor's office.

The main objective is to optimize particle types for use in analytical and diagnostic assays (discussed in greater detail in Section 5.4, below). In many of the applications, the particles is coated with a macromolecular substance such as polymer, protein, or the like to confer suitable chemical stability in various mediums, as is known in the art. For example, it is well known that silver rapidly oxidizes. One can chemically stabilize the silver particles or particles of mixed composition containing silver by applying a coating, e.g., a thin coat of gold or other substance, on the surface such that the silver is no longer susceptible to environmental effects on its chemical stability. Binding agents such as antibodies, receptors, peptides, proteins, nucleic acids, and the like can also be placed on the surface of the particle so that the coated particle can be used in an analytic or diagnostic format. Any techniques known in the art can be used to attach binding agents to the particles directly or indirectly by the use of functionalized linkers and specific binding pairs such as the biotin-avidin system. For examples, see Bioconjugate Techniques, G. Herrnanson, Academic Press, 1996, Chapters 4, 5, 13, 14, and 17 which are incorporated herein by reference in their entireties. In some applications, the binding agent serves a dual function in that it stabilizes the particle in solution and provides the specific recognition binding component to bind the analyte. The coating of particles with proteins such as antibodies is known in the art. It has been determined by physical experimentation and theoretical modeling that the presence of thin coats of binding agents, non-optically absorbing polymers (in the visible region of the spectrum), or other materials on the particle surface does not noticeably alter the light scattering properties specific for that type of particle which is not coated with these types of materials.

### 5.3.5 Specific Light Scattering Properties of Particles

The most preferred light scattering properties that can be used to detect analytes in the present invention using a variety of different assay formats are presented in U.S. Pat. Nos. 6,214,560 and 6,586,193, which are incorporated herein in their entireties, including drawings. The measured light scattering properties that are detected are one or more of the intensity, the wavelength, the color, the polarization, the angular dependence, and the RIFSLIW (rotational individual fluctuations in the scattered light intensity and/or wavelengths) of the scattered light of the scattered light.

Coated and uncoated metal-like particles have similar light scattering properties and both have superior light scattering properties as compared to non-metal-like particles. In addition, it has been determined that it is relatively easy to adjust the types of light scattering properties in metal-like particles by varying in one form or another, the size, shape, composition, and homogeneity such that the specific light scattering attributes can be measured from the metal-like particle in various sample types.

One or more types of metal-like particles are detected in a sample by measuring their color under white light or similar broad band illumination with DLASLPD type illumination and detection methods. For example, roughly spherical particles of gold (for example, coated with binding agent, bound to analyte, released into solution or bound to a solid-phase) of 40, 60, and 80 nm diameters and a particle of silver of about 30 nm diameter can easily be detected and quantitated in a sample by identifying each particle type by their respective unique scattered light color and/or measuring the intensity. This can be done on a solid phase such as a microtitier well or microarray chip, or in solution.

For solid-phase analytical applications, a very wide range of concentrations of metal-like particles is detectable by using particle counting alone or in combination with integrated light intensity measurements depending on the concentration of particles. The particles can be detected from very low to very high particle densities per unit area.

In other assay applications, the particles which are bound to a solid substrate such as a bead, a surface such as the bottom of a well, or the like can be released into solution by adjusting the pH, ionic strength, or other methods. Higher refractive index liquids can be added, and the particle light scattering properties are measured in solution. Similarly, particles in solution can be concentrated by various means into a small volume or area prior to measuring the light scattering properties. Again, higher refractive index liquids can be added prior to the measurement.

### 5.3.6 Mixed Composition Particles

Particles composed of certain mixed compositions of metal-like materials, as for example, mixed compositions of gold and silver, exhibit novel light scattering properties which can be exploited in many different sample types and specific diagnostic and analytic applications. Particles with two or more optically distinct and resolvable wavelengths of high scattering intensities can be made by varying the composition of the metal-like-materials.

In contrast, particles composed of mixed compositions of non-metal-like and metal-like materials generally exhibit light scattering properties similar to the metal-like materials at equal proportions or less of non-metal-like materials to metal-like materials. Only at very high proportions of non-metal-like to metal-like materials do the light scattering properties of the mixed composition particle resemble that of the non-metal-like material.

Both the mixed silver-gold compositions and the silver-polystyrene compositions exhibit the high light scattering power and visible wavelength scattering bands which are characteristic of particles composed of pure metal-like materials. Particles of certain mixed compositions are detectable by specifically detecting the scattered light from one or both of the scattering intensity peaks and or by the color or colors of these mixed composition type particles. Such mixed composition type particles enhances the capability for detecting lesser amounts of particles and more specifically, detecting lesser and greater amounts of particles than was previously possible.

### 5.3.7 Asymmetric Particles or Non-Spherical Symmetric Structures

The physical orientation of non-spherical particles, such as asymmetric or symmetric non-spherical particles with regard to an incident light beam allows for additional scattered light properties to be used in the detection of these particles. Non-spherical structures include oblate spheroids, cylindrical structures such as rods, cylinders, cones, and other particle structures with triangular, hexagonal or polygonal sections. Particles that are elliposidal, cubical, tetrahedral, polyhedral, or pyramidal in shape are also encompassed.

The characteristics of the light (such as color, wavelength, polarization, etc.) scattered by a non-spherical structure is highly dependent on its geometry and its orientation relative to the polarization of the illuminating light beam. This unique property is responsible for the observation of rotational individual fluctuations in the scattered light intensity and or wavelengths (RIFSLIW).

Small non-spherical particles (whether symmetric or asymmetric) behave somewhat as linear dipole scatterers with different absorption and emission moments along the long or major axis of the particle as compared to the minor axis. Under illumination with linearly polarized light, unbound or weakly bound non-spherical particles flicker as they move (e.g., by rotation). The scattered light is most intense if the major axis of the particles is oriented in the direction of polarization of the illuminating light, and is less or at a minimum when the moment is oriented in any other direction (e.g., perpendicular to the major axis). In contrast, small spherical particles do not flicker when illuminated by polarized light. For non-spherical particles of certain compositions, the color of the scattered light (e.g., under white light illumination) changes with the degree of asymmetry. As the asymmetry is increased, the color shifts towards longer wavelengths. For example, asymmetric particles of silver were observed to change colors as the particles were rotating in solution when viewed with an ordinary light microscope under DLASLPD like conditions. RIFSLIW is used in many different aspects of the current invention to more specifically and more sensitively detect and or measure one or more analytes or particles in a sample.

The property of RIFSLIW can be used in many different aspects of the current invention to more specifically and more sensitively detect and or measure one or more analytes or particles in a sample. For example, the flickering of the scattered light intensity and/or change in color provides additional detection means to determine which particles are bound to a surface and which particles are not. This allows for non-separation type of assays (homogeneous) to be developed. All that is required is to detect by particle counting, intensity measurements or the like the particles that do not flicker and/or change color. Unbound particles in solution will flicker and/or change color while those bound to the surface will not. Additional image processing means such as video recorders and the like allow for additional methods of detection to be used with both asymmetric and spherical (symmetric particles). For example, in either a separation or non-separation format, the bound particles are detected by focusing the collecting lens at the surface and only recording those scattered light signals per unit area which are constant over some period of time. Particles free in solution undergoing Brownian motion or other types of motion results in variable scattered light intensity per unit area per unit time for these particles. Bound light scattering particles are fixed in space and are not moving. By using image-processing methods to separate the “moving” light-scattering particles from the “bound” light scattering particles, the amount of bound particles is determined and correlated to the amount of analyte in the sample. One of skill in the art will recognize there are many other image processing methods that can be used to discriminate between bound particles to a surface and unbound spherical or asymmetric particles in solution.

In various embodiments, the orientation of the non-spherical particles in any one layer of the waveguide can be random, i.e., the major axis and minor axis of the non-spherical particles are not aligned with each other or with the surfaces or edges of the waveguide. In certain embodiments, the orientation can be non-random. Preferably, the major axis of the non-spherical particles are not oriented parallel to the surface of the waveguide and/or the minor axis of the non-spherical particles are not oriented perpendicular to the surface of the waveguide.

### 5.3.8 Manipulatable Light Scattering Particles

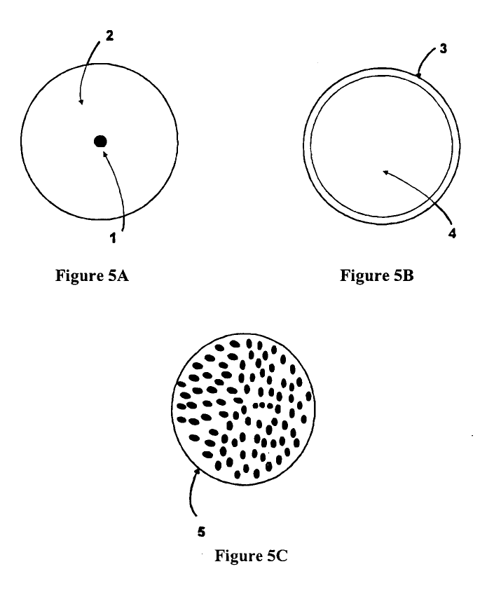

Manipulatable Light Scattering Particles (MLSP) are particles, which in addition to having one or more desirable light scattering properties, can also be manipulated in one-, two- or three-dimensional space by application of an electromagnetic field (EMF). A MLSP particle can be made in many different ways. For example, a MLSP particle is made by coating a small diameter “core” ferro electric, magnetic or similar material with a much greater proportion of a material that has the desirable light scattering properties, for example a 10 nm diameter core of magnetic or ferroelectric material is coated with enough gold to make a 50, 70, or 100 nm or larger diameter particle (see FIG. 5A).

Another method of making such a particle is to coat the material that has the desirable light scattering properties with a thin coat of the magnetic or ferro electric material. For example, a gold or silver particle of about 50 nm is coated with a 1-2 nm thick coat of the magnetic or ferro electric material, as illustrated in FIG. 5B.

Alternatively, the MLSP particles are made by mixing in the appropriate proportions the light scattering desirable materials and the ferro electric or magnetic materials such that as the particle is formed, the appropriate proportions of light scattering desirable material to magnetic or ferroelectric material per particle ratio is attained (see FIG. 5C).

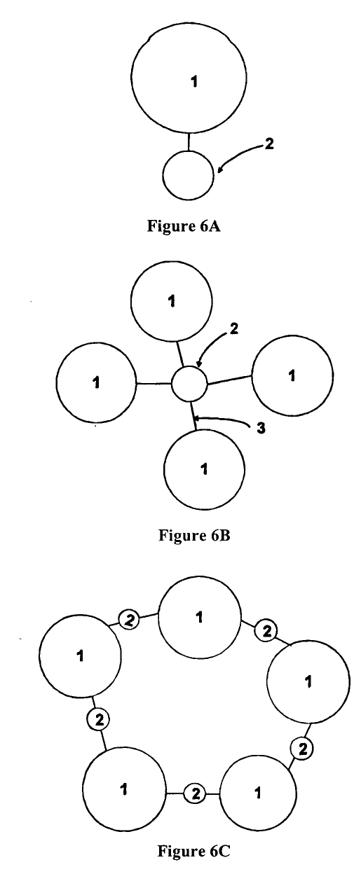

An alternative to the above MLSP particles is to link or assemble one or more types of particles with desirable light scattering properties to one or more particles that can be moved by a EMF. Such multi-particle structures (see, e.g., FIGS. 6A, 6B and 6C) can then have similar properties to the MLSP's. For example, small particles of magnetic or ferro electric material are linked to one or more particles with detectable light scattering properties. The linking can be by ionic, chemical or any other means that results in a stable multi-particle structure. For example, the different particles are coated with appropriate polymers so that when mixed in the proper portion, a defined distribution of discreet multi-particle structures are achieved by crosslinking the different types of individual particles together. There many different ways to link the particles together to achieve the desired multi-particle structure(s). For illustrative purposes, a few of the possible multi-particle structures are shown in FIGS. 6A, 6B, and 6C, which show dimer, tetramer, and higher order particle constructs, respectively, for orientable MLSP particles. It is also envisioned that the multi-particle structure can be formed from a linear arrangement of two or more particles. One skilled in the art will recognize that these are just a few of the many different types of multi-particle structures possible and there are numerous methods to make such structures.

These examples of particles composed of mixtures of one or more material are but a few of a very large number of different compositions of different materials which are possible, and which would be apparent to one of skill in the art.

### 5.3.9 Multi-Analyte Detection

In certain applications, the color of the individual particles are used to identify and quantitate specific types of analytes. For example, in image cytometry applications, it may be of interest to identify and count different types of cell surface antigens or the like by detecting the number and color of different types of particles attached to the surface. For this or any other related type of multi-analyte detection, the size distributions of the different particles need to be kept as tight as possible. The average particle diameter of the particle preparation should be chosen to provide the desired color of scattered light under white light illumination, using an average or “mean” particle size that is as close to the size midpoint between the mean particle sizes of smaller and larger particles which will be used in the same application to produce different colors of scattered light. In this fashion, the resolvability of the different types of particles by their color of scattered light is maximized.

FIG. 4A shows the calculated scattered light intensity versus incident light wavelength spectra profiles for spherical gold particles of varying diameter. The scattered light intensity peak wavelengths shift to longer wavelengths as the size of the gold particles is increased. These light scattering properties for coated or uncoated gold particles of 40, 60, 80, 100 nm diameters are similar and they appear as green, yellow-green, orange, and orange-red particles when illuminated with a white light source. Small spherical silver particles appear blue (i.e., approximately 20-80 nm in size, see FIG. 3A). Thus, metal-like particles coated with various types of binding agents can be used in numerous ways in analytic type assays.

The configurable properties of scattered light detectable particles, e.g., the color of different types of metal-like particles, allows for multi-analyte detection. FIG. 7 illustrates how one skilled in the art would choose the appropriate particle composition, shape, size and homogeneity to suit a specific diagnostic analytic testing need with detection of the desired light scattering properties of the particles. By varying the size and/or shape of silver particles and other metal-like particles, many different colors of light absorption can be achieved. Depending on how the light scattering properties of particles are detected, the approximate size and distribution of particle sizes in the particle population can be extremely important. As an example, many of the commercially available gold particle preparations quote the particle size distributions any where from about <10 to about <20 percent coefficient of variation. Percent coefficient of variation is defined as the standard deviation of the particle size distribution divided by the mean of the particle preparation. Thus, for a 60 nm particle preparation with a coefficient of variation of 20%, one standard deviation unit is about +12 nm. This means that about 10% of the particles are smaller than 48 nm or greater than 72 nm. Such variation in size has significant effects on the intensity of scattered light and the color of scattered light depending on the approximate “mean” size of the particles in the preparation. Preferably, the particles of the populations are of a narrow size distributions, i.e., have a low coefficient of variation such that different populations of particles are distinguishable by their light scattering properties.

Different populations of light scattering particles can be used in the detection of different types of analytes in a multi-analyte assay (i.e., multiplex assay), where each population of particles used for the detection of a particular type of analyte is configured to emit scattered light that is distinguishable from that of any other populations of particles. For example, spherical gold particles of 40, 60, 80, and 100 nm diameter and 20 nm diameter silver particles, each coated with a different type of binding agent, can be used in the same sample to detect five different analytes in the sample. In one format, five different types of cell surface receptors, or other surface constituents present on the cell surface can be detected and visualized. The number and types of analytes are identified by the number of green, yellow, orange, red, and blue particles detected. Similarly, chromosome and genetic analysis such as in situ hybridization and the like can also be done using the method as described above where the different types of metal-like particles are used as “chromosome paints” to identify different types of nucleic acid sequences, nucleic acid binding proteins, and other similar analytes in the sample by the color of the scattered light of the different types of metal-like particles. These examples are provided as illustrative examples, and one skilled in the art will recognize that the color of the scattered light of different types of metal-like particles can be used in many different assay formats for single or multi-analyte detection.

One skilled in the art can practice many different aspects of this invention by using a waveguide with various particle types, with many different particle type configurations, in order to achieve a desired diagnostic or analytic detection capability.

### 5.4 USES OF THE WAVEGUIDES: ANALYTE ASSAYS

The invention also provides methods for using a waveguide of the invention for the specific detection of one or more analytes labeled with light scattering particles. In certain embodiments, the present invention is capable of detecting individual light scattering particles and discreet, individual molecular binding events. The waveguide as described in previous sections is a layered structure comprising an optically transmissive layer and a coating layer with refractive index greater than or equal to that of the optically transmissive layer. The coating layer comprises one or more scattered light detectable particles of a size between 1 and 500 nm inclusive, wherein each scattered light detectable particles is adapted to bind one or more analytes. The coating layer may further comprises one or more of the analytes of interest which may be bound to the particles. The light scattering particles are used as labels as fluorophores, chemiluminescent molecules, radioactive isotopes, and enzymes are used in a wide variety of chemical, biochemical and biological assays well known in the art. Typically, the assay reaction is carried out partially or completely on a surface which forms a part of the waveguide, such as the first light propagating layer as described in section 5.1. Alternatively, the assay reaction is carried out separately in an appropriate container prior to the detection step when the reaction is deposited onto a surface which is or which forms a part of the waveguide. Light is coupled into the waveguide by any of the above described methods, thereby illuminating the one or more scattered light detectable particles with non-evanescent wave light under conditions which produce scattered light from said particles and in which light scattered from one or more said particles can be detected by a human eye with less than 500 times magnification and without electronic amplification. Depending on the configuration and format of the assay, the light scattered by the particles and detected in the waveguide serves as a measure of the presence or absence and if present, the quantity of an analyte in the assay reaction. Multiple populations of light scattering particles that produce distinguishably different qualities of light (e.g., two different colors) can be used in a multi-analyte assay to detect different analytes. In such an assay, each population of light scattering particles is adapted to bind specifically to one species of analyte, and each species of analyte can be detected separately or simultaneously.

The present invention can be used to detect and measure a wide range of analytes. The analytes can be biological entities, including but not limited to viruses, bacteria, prokaryotic cells, microorganisms, fungal cells, pathogens, yeasts, eukaryotic cells, organelles, subcellular structures, live cells, dead cells, spores, a single cell organism, a cell of a multicellular organism, and the like. The analytes can be naturally occurring or synthetic molecular entitites, free in fluid phase, or associated with a solid phase, e.g, attached to a cell surface. Such analytes can include but are not limited to proteins, peptides, protein-lipid complexes, lipids, nucleic acids, nucleic acid-protein complexes, carbohydrates, glycoproteins, glycolipids, and carbohydrate-containing substances, natural products, molecules synthesized by combinatorial chemistry, and any naturally occurring and synthetic macromolecules. Examples of such analytes include pharmaceutical agents, pharmaceutical drug targets, metabolites, antibodies, cytokines, receptors, hormones, enzymes, antigenic substances, toxins, diagnostic, biological or environmental indicators. The analytes can also be the products and by-products of chemical manufacturing processes and micrometer-nanometer-scale manufacturing processes.

As described above, multiple populations of light scattering particles that produce distinguishably different qualities of light can be used to detect different analytes, or same analytes obtained from different sources. Many types of assays have been developed to detect and measure these analytes, and can be modified and improved by using a waveguide for light signal detection. Immunoassays, nucleic acid assays, and many other ligand-receptor assays are well known in the art. For a review of the different types of assays that can be adapted to use a waveguide for signal detection, see Immunoassay, Diamandis and Christopoulus, Academic Press, 1996, Chapters 3, 8, 9, 10, 11, 18, 19 and 24; Immunoassay Handbook, 2^{nd} edition, D. Wild, Nature Publishing Group, 2001, Chapters 1, 5, 6, 10 and 11; and Immunoassays: A Practical Approach, J. Gosling, Oxford University Press, 2000, pages 7-14 and 129-153, which are incorporated herein by reference in their entireties. Both heterogenous and homogenous assays are encompassed.

In one embodiment, the waveguide of the invention can be used in assays that involve one or more specific molecular binding pairs. One member of a specific binding pair is used as a probe to detect and measure the presence of its partner, the analyte of interest. A label becomes detectably associated with the analyte either as a direct result or an indirect result of the binding of the probe to its partner. In a related embodiment, a second accessory specific binding pair is used in the assay. The secondary binding pair are typically used to amplify the signal since one molecule of one species of the secondary binding pair can bind multiple partner molecules. The secondary binding pair may also be used to take advantage of the convenience of using reagents that are commercially available. Examples of commonly used secondary binding pairs include but are not limited to biotin and avidin/streptavidin/antibiotin antibodies; digoxinin and antidigoxinin antibodies; fluorescein and antifluorescein antibodies. For examples, see Bioconjugate Techniques, G. Hermanson, Academic Press, 1996, Chapters 13, 14, and 17 which are incorporated herein by reference in their entireties. Many methods well known in the art can be used to attach such accessory molecules to components of the assay. See for example, Nonradioactive Labeling and Detection of Biomolecules, C. Kessler, Springer-Verlag, New York, 1992, which is incorporated by reference in its entirety.

In the present invention, light scattering particle labels become detectably associated to an analyte by one of several methods. In one embodiment, the probe molecule (e.g. antibody, complementary nucleic acid etc.) is directly labeled with light scattering particles, and binds the analyte in the assay reaction. In another embodiment, the probe molecule that binds the analyte is attached with one or more molecules of a member of a secondary binding pair. The corresponding partners of the secondary binding pair, labeled with light scattering particles, bind the probes that are in turn bound to the analytes. In yet another embodiment, the light scattering particle labels are attached to an agent (e.g., an antibody, nucleic acid intercalating substance, nucleic acid binding proteins) that have specific binding properties for the complex formed between probe and analyte. The labeled agents bind the complexes formed in the assay reaction.

In general, the assay method comprises the steps of preparing an assay reaction comprising a sample that may contain the analyte, and a probe, and allowing sufficient time for the probe and analytes to interact and bind to each other, thus forming a complex, which may be a transient complex. The formation of the complex can be detected in the assay reaction, or the formed complexes can be removed from the reaction for detection. Alternatively, the label remaining in the reaction after the removal of the complexes is detected.

In one particular embodiment, the assay method involves anchoring either the probe or the analyte onto a solid phase, and detecting the probe-analyte complexes anchored on the solid phase at the end of the reaction. In one embodiment of such a method, the probe may be anchored onto a solid surface, and the analyte, which is not anchored, may be labeled with light scattering particles, either directly or indirectly. In practice, many surfaces can be used as the solid phase, e.g., the wells of microtiter plates or the surface of a glass slide may conveniently be utilized. The anchored component may be immobilized to the solid phase by non-covalent or covalent attachments. Non-covalent attachment of proteins may be accomplished by simply coating the solid surface with a solution of the protein and drying. Alternatively, an immobilized antibody, preferably a monoclonal antibody, specific for the protein to be immobilized may be used to anchor the protein to the solid surface. The surfaces may be prepared in advance and stored under appropriate conditions.

In order to conduct an assay using a solid phase with anchored molecules, the nonimmobilized component is added to the solid phase coated the anchored component. After the reaction is complete, unreacted components are removed (e.g., by washing, and flicking the droplets off) under conditions such that any complexes formed will remain immobilized on the solid surface. The detection of complexes anchored on the solid surface can be accomplished in a number of ways. Where the previously nonimmobilized component is pre-labeled, the detection of label immobilized on the surface indicates that complexes were formed. Where the previously nonimmobilized component is not pre-labeled, an indirect label can be used to detect complexes anchored on the surface; e.g., using a labeled antibody specific for the previously nonimmobilized component (the antibody, in turn, may be directly labeled or indirectly labeled with a labeled anti-immunoglobulin antibody).

Alternatively, the assay reaction is conducted in liquid phase. After the reaction products are separated from unreacted components, the complexes are detected, for example, using an immobilized first antibody specific for the probe or the analyte to anchor any complexes formed in solution, and a labeled second antibody specific for the other component of the complex to detect the captured complexes.

Illumination and detection methods based on the waveguides of the invention are used to produce and detect the light scattering signal. One or more wavelengths of illumination and/or detection may be used depending on the nature of the assay. In assay formats where two or more particles come into close proximity, the changes in light scattering intensities, polarization, angular dependence, wavelength, or other scattered light properties can be used to detect and measure the binding.

Below is described several applications of the present invention for the detection and measurement of a wide variety of analytes. The examples and discussion below are not meant to be limiting, but rather to show the broad utility of various embodiments of the present invention. Those of skill in the art will realize that there are many variations of the present invention.

### 5.4.1 Nucleic Acid Detection and Analysis

The demand for accurate and rapid detection and analysis of nucleic acids continues to grow. In many situations, the amount of nucleic acid sequence that is present is very low with perhaps just a few or even one copy of the sequence per sample, cell or organism. In order to be able to detect the presence of the nucleic acid sequence, sophisticated methods of “target amplification” for example Polymerase Chain Reaction (PCR), Nucleic Acid Sequence Based Amplification (NASBA), Transcription mediated amplification (TMA) and other nucleic acid sequence amplification technologies must be used. These methods add significant complexity to the assay and must be carefully controlled and monitored. Signal amplification technologies have also developed. Chemiluminescence, electrochemiluminescence and enzyme based calorimetric or fluorescent signal amplification systems are examples. For example, Colorimetric-based detection methods are generally limited to micromolar (10⁻⁶ M to 10⁻⁸ M) detection sensitivities. Fluorescence-based methods improve the detection sensitivity and have detection sensitivities in the nanomolar to subnanomolar ranges (10⁻⁸ to 10⁻¹¹ M). Problems associated with fluorescence labels and methods include photodecomposition and quenching phenomenon. In many instances, other agents in the sample can interact with fluorescent labels causing the signal being detected to vary. Chemiluminescence-based methods provide good detection sensitivities (10⁻¹² M and below) but require special reagents and careful handling techniques and the chemiluminescence reactions are susceptible to interferences from components in the sample. Radioisotope techniques are among the most sensitive known but require special handling procedures, and use hazardous materials, which are generally difficult to use, and are expensive. The use of light scattering labels with a waveguide using evanescent illumination to detect nucleic acid hybridization is described in U.S. Pat. No. 5,599,668 and Stimpson et al., Proc. Natl. Acad. Sci., USA, 92: 6379-6383 (1995). The present invention differs from waveguides that use evanescent illumination in that the labels in the present invention reside in the medium of higher refractive index and thus cannot be illuminated by evanescent light. Furthermore, many technical problems are associated with the evanescent technique of illumination.

The present invention has overcome many of the limitations of the evanescent method. By using hybridization techniques in combination with one or more embodiments of the present invention, specific target nucleic acid sequences can be detected and measured more easily and with greater detection sensitivity than was previously possible. The enablement of greater detection sensitivity with less time consuming and complicated methods and equipment allows for the more widespread detection and analysis of nucleic acids in many different fields including medical, biological, and biochemical research, pharmaceutical drug discovery and development, veterinary and clinical diagnostics, agriculture, food, water, industrial and environmental science.

In various embodiments, the present invention provide methods for identification and measurement of nucleic acid molecules including RNA, DNA, and other polynucleotides. For example, HnRNA (heterogeneous RNA), tRNA (transfer RNA), mRNA(messenger RNA), ribosomal RNAs (rRNA), and complementary DNA (cDNA) can be detected, measured and analyzed. The present invention can be applied to the studies of genetic polymorphisms, linkage patterns, identification of gene mutations, chromosomal aberrations as well as measurement of expression levels of one or more genes in a cell. The present invention can also be used to detect, measure, and analyze nucleic acid sequences which are synthesized by chemical methods, such as but not limited to, oligonucleotides (including DNA tags or DNA barcodes), peptide nucleic acids (PNA) and the like.

Nucleic acid hybridization methods are of great utility in the detection and identification of nucleic acid sequences. The method of hybridization and hybridization assays make use of the unique physico-chemical properties of nucleic acids which allows for double stranded and even triple stranded structures to form between two or more nucleic acid strands which are complementary to one another. Many different variations of the hybridization method exist and many different assay formats have been developed to perform a hybridization assay. Art known methods such as those described in Nucleic Acid Analysis: Principles and Bioapplications, C. A. Dangler, Wiley-Liss, New York 1996 and DNA Arrays: methods and protocols, J. B. Rampal, Humana Press, 2001, are incorporated by reference herein in their entireties.

In a hybridization assay, a nucleic acid with a known sequence is used as a probe to detect in a sample a target nucleic acid, i.e., the analyte of interest which has a nucleic acid sequence complementary to one or more regions of the probe nucleic acid sequence. The probe nucleic acid is added to the sample and the probe binds to a target having complementary sequence under a certain stringency condition, if such a target is present in the sample. Following the hybridization reaction, the probe-target complex can be detected and measured by the light scattering particle labels that are attached directly or indirectly to the probe nucleic acid or to an agent that binds the probe-target complex.

Those of ordinary skill in the art will recognize that there are many different methods for the labeling a nucleic acid molecule with a light scattering particle. For example, direct methods include the chemical or photochemical modification of one or more chemical groups of the nucleic acid for new chemical groups that are used to form a chemical bond or other linkage to the surface of a light scattering particle. Methods of transamination as described by Shapiro et al., Biochem. Biophys. Res. Commun., 40:839-843 (1970); Shapiro et al., Adv. Exp. Med. Biol., 86A:633-640 (1977); and Miller et al., Bioconjug. Chem., 3:74-79 (1992), which are incorporated by reference herein, can be used to develop reactive amino groups on cytosine residues.

Alternatively, a secondary binding pair as described above is used. For example, one or more molecules of biotin, fluorescein or digoxigenin is incorporated into the target nucleic acid sequence by any of the art known techniques including: (1) the use of individual nucleotides derivatized with one of these accessory molecules in the synthesis of the target nucleic acid sequence; (2) chemical or photochemical reaction of these accessory molecules with the target nucleic acid sequence at the 3′ or 5′ ends; or (3) use of biochemical and/or enzymatic methods to incorporate the accessory molecules.

The study of gene expression is becoming very important in many different fields including disease diagnosis, drug target development, and genetics and developmental biology research. One preferred embodiment of the invention is its application in the determination of gene expression. In recent times, there has been much effort in the development of new methods and strategies to measure gene expression levels and to increase the rate at which information is gathered. For example, array-based methods that involve the attachment of multiple cDNAs onto glass or other substrates have been reported (Schena et al., Science 270:467-470 (1995); Shalon et al., Genome Research 6:639-645). An alternative array method for measuring gene expression utilizes oligonucleotide arrays (Lockhart et al., Nat. Biotechnol. 14:1675-1680 (1996)). These approaches and those described in DNA Arrays: methods and protocols, J. B. Rampal, Humana Press, 2001, can be used with waveguides of the invention, and are incorporated by reference herein in their entireties.

To determine the relative or absolute expression levels of any given gene, the concentration of mRNA, a product of gene expression, accumulated in an organism or cell is determined. Current art-known array-based methods use fluorescent labels to detect and measure the hybridization of nucleic acids (typically cDNAs) obtained from a sample to an array, the amount of hybridization being correlated to the amount of MRNA of a particular gene in a sample.

The present invention provides an exemplary gene expression assay that is based on an array and a waveguide to assess, detect, and quantify the expression level of one or more genes in a sample. The array comprises one or more solid phases or surfaces which comprise oligonucleotides, DNAs, RNAs, or other nucleic acids that will serve as probes. These probe nucleic acids hybridize to target nucleic acids that comprise at least one contiguous stretch of complementary nucleotide sequences. The stretch of complementary nucleotide sequences can be at least 10, 11, 12, 13, 14, 15, 16, 17, 18, 19, 20, 21, 22, 23, 24, 25, 30, 40, 50, 75, 100, 200, 250, 300, 400, 500 bases. The target nucleic acid can be but not limited to a specific mRNA, a cDNA produced from a mRNA, or a nucleic acid produced by in vitro transcription using as template a cDNA copy of a target mRNA. Thus, if the mRNAs of a sample are being analyzed on an array then the mRNAs are the target nucleic acids. If cDNAs or in vitro transcribed nucleic acids are used as intermediates, the cDNA and the in vitro transcribed nucleic acids are the target nucleic acids.

In a preferred embodiment, the target nucleic acids are labeled directly with one or more light scattering labels by methods known in the art, e.g., U.S. Pat. No. 6,214,560 or published PCT patent application WO97/40181; and hybridized to the probes on the array under a certain stringency condition. The array is then washed one or more times with the appropriate buffer under the appropriate stringency condition to remove the unreacted and excess target nucleic acid, and possibly other substances in the sample that may interfere with signal generation and/or increase the background. The array comprising bound light scattering particles can then be coated or covered with a material that transmits light and has a higher refractive index than the material of the array to form a waveguide as described herein.

In another embodiment, MRNA levels can be detected and measured directly in gene expression arrays or other formats by labeling deoxythymidine multimers or oligonucleotides (oligo-dT) with light scattering particles to form a nucleic acid-particle reagent that binds to polyadenylation (poly(A)) sequences. It is well known in the art that most mRNA molecules contain a polyadenylate sequence (“poly(A)”) at the 3′ end of the molecule. This poly(A) tail is often made of use in the purification of mRNAs from samples with the use of a separation column containing oligo dT. To perform the assay an array is constructed which has nucleic acid probe molecules having sequences complementary to the mRNAs of interest immobilized on the surface preferably in spatially discrete and addressable areas. The sample mRNA is collected and applied to the array under hybridization conditions. The oligo dT-labeled light scattering particles can be added to the sample prior to, during, or following hybridization. The oligo-dT labeled with light scattering particles hybridize to the poly(A) sequences on the bound mRNAs. After the unreacted and excess reagents are washed off the array, a waveguide is formed on the array by coating the array with a light transmissive material that has a refractive index higher than that of the array. The presence and amount of any given MRNA target in the sample is determined by measuring the amount of light scattering signal in the areas of the array that has the complementary nucleic acid sequence to that target mRNA.

In another embodiment of the present invention which is applicable both to the measurement of gene expression and nucleic acid detection and measurement, specific nucleic acid sequences, DNA binding proteins, or other molecular recognition agents are attached to light scattering particles and used to detect the presence and amount of a target nucleic acid sequence. For example, one or more poly(A) sequences or another homopolymer pair of sequences such as poly(I) and poly(C) can be used to create a secondary binding pair for detection of the target nucleic acid sequence.

In an alternative method, a nucleic acid or DNA binding protein is attached to a light scattering particle and the nucleic acid binding protein-particle reagent is used as a detection probe for the presence of the target sequence. The sequence of the nucleic acid that the DNA binding protein binds to can be naturally occurring in the target sequence, or, it can be attached to a target or probe nucleic acid sequence involved in the assay procedure.

In an additional method, light scattering particles are attached to probe molecules which have specific binding properties for DNA-DNA duplexes, RNA-DNA duplexes, or even triple-stranded structures. For example, it is well known that there are many compounds which show specific binding properties for double-stranded nucleic acid structures. Ethidium bromide, dimers thereof, and other variations of this molecule bind to double-stranded nucleic acid structures. Thus, in this variation of the method, a light scattering particle-ethidium bromide reagent is prepared and added to the gene expression array following hybridization. The presence and amount of expression is determined from the amount of light scattering detected in the binding zone after the waveguide is formed.

### 5.4.2 Protein and Cell Identification and Measurement

The present invention can also be used to detect and measure protein expression in a cell or protein concentration in a sample. In this embodiment, one or more light scattering particles are attached to an antibody, a ligand, a receptor, or other binding agent that has binding specificity for the protein of interest. Various art known assay formats can be used including but not limited to immunological assays described earlier as well as assays applicable in protein analysis and proteomics. For example, methods described in Protein-Protein Interaction: A Molecular Cloning Manual, Golemis and Serebriiskii, Cold Spring Harbor Press, 2002; and 2-D Proteome Analysis: Protocols, Link, Humana Press, 1998, are incorporated herein by reference in its entirety. The presence and amount of one or more species of protein present in a sample is determined by the detection and measurement of the light scattering signal in the waveguide.

The waveguides of the present invention can also be used in different formats with light scattering labels to detect specific cell types and organisms in a sample. A microorganism, a cell of an organism, or a specific type of cell can be detected in a sample by using immunological reagents (e.g., antibodies or fragments thereof), lectins, carbohydrates, pharmaceutical compounds, and other substances that bind specifically to certain types of cells. For example, a light scattering particle-antibody conjugate reagent is prepared where the antibody is specific for a cell surface antigen of a cell of interest. The light scattering particle-antibody conjugate reagent is applied to the sample, allowed to incubate, and then the labeled cells are prepared for analysis in a waveguide of the invention. As described elsewhere, a microscope-based or other imaging instrument can be constructed for detection and analysis of light scattering particles present in a waveguide.

The detection and measurement of organisms in a sample can be performed by utilizing one or more aspects of the present invention. In this embodiment, specific light-scattering particle-antibody conjugates can be prepared which have specific binding properties for a surface antigen on the organism, a chemical or biological substance that is produced by the organism, as for example a toxin, or any other substance which is specific for the organism. In one particular embodiment, a sandwich immunoassay format is used. A particle-conjugate reagent is made which has specific binding properties for a known toxin molecule or surface antigen of a bacterium or virus. A microwell, plastic, glass or other solid-surface is coated with an antibody that can specifically bind to the surface analyte or toxin. The sample and particle-conjugate reagent can be mixed together prior to application to the solid-phase or, a two-step approach is used. In the two-step approach, the sample is applied to the container, washed, then the particle-conjugate is applied. In either approach, following incubation with the particle conjugate, the solid-phase is washed and a waveguide is formed by adding a light transmissive layer on the solid phase. The amount of organism in the sample is determined by the presence and amount of light scattering signal detected by waveguide-based methods.

In a different embodiment, an aggregation format is performed in solution. Light scattering particles are coated with molecules of a specific binding agent. The particle-reagent is added to the sample and if the target organism is present, multi-particle aggregates will form. The number of multiparticle aggregates, or light scattering properties of the aggregates, or the decrease in particle-binding agent reagent can be used to detect and measure the amount of organism present.

In another embodiment, an array-based device which has cell specific antibodies, lectins, or other molecular recognition agents attached to the array in spatially distinct areas is used to capture the different cells into different areas of the array. A light scattering particle reagent is used to label the cells prior to or following the application of the sample to the array. In another example, a virus or bacterium is detected and measured by using the present invention and specific monoclonal or polyclonal antibodies which specifically recognize viral or bacterial antigens specific for the species and/or strain of the organism. On a solid-phase made of glass, plastic or other optically transparent medium, antibodies are coated onto the surface that are specific for the organism that is being detected. The solid-phase can be in a chip, dipstick or other form. One or more specific binding agents can be used on the surface of the solid-phase in discreet areas in an array or other pattern. The sample is applied to the solid-phase. During or following incubation and/or following washing, a solution containing light scattering particles attached to specific antibodies which bind to the viral or bacterial antigen is applied. The solid-phase is then removed from the solution containing the light scattering particle-antibody conjugate and treated appropriately to form a waveguide prior to detection or measurement. The presence and/or amount of organism present is determined by detecting and/or measuring the amount of light scattering signal coming from the waveguide above the binding zones of the solid-phase. Detection and measurement can be done by the unaided or aided eye, or by imaging or non-imaging photodetection and analysis as described elsewhere herein. Multiple viruses or bacteria can be detected and measured in a similar fashion by using several different binding zones on the solid-phase where each binding zone contains a binding agent specific for a virus, bacteria, or antigens that are specific for a particular strain of the organism. Those of average skill in the art recognize that there are many other different formats possible to utilize the present invention in one form or another to detect the presence and amount of cells or organisms in a sample.

### 5.4.3 Pharmaceutical Target and Drug Identification

The present invention in various embodiments has great utility in the field of pharmaceutical drug discovery and development. In recent years, there has been an explosion of new methods and techniques for drug discovery. Combinatorial chemistry methods have developed which allow for the rapid construction of synthetic, biological, or biosynthetic libraries consisting of many thousands of unique molecules which may have potential as pharmaceutical agents. For example, a recent publication contains several articles related to combinatorial chemistry and serves as a good source for background information (Chemical Reviews Volume 97, Issue 2 (1997)), and methods described therein are incorporated by reference herein. Furthermore, combinatorial biological libraries which use plasmid, polysomes, and phage display methods are also encompassed. Spatially addressable library methods include the multipin system, multiple synthetic techniques which use segmentable carriers, synthesis on planar solid supports (SPOT) synthesis on cellulose paper or polymeric membrane, light-directed synthesis on glass surfaces, gene expression arrays, and diversomer technology. Additionally, the methods of positional scanning, orthogonal partition, and an iterative approach in general are known in the art. Also, the one-bead-one-compound combinatorial library method and synthetic solution library methods, affinity chromatography selection, and affinity capillary electrophoresis are also encompassed. Brief descriptions and further detailed disclosures of these methods can be found in the publication of Lam et al. Chemical Reviews 97: pp. 411-448 (1997). All of these methods and the references cited in the publication of Lam et al. are incorporated by reference herein.

Combinatorial methods typically consist of three main steps: (1) construction of a library;(2) screening of the library for activity; and (3) determination of the active identity of the active substance(s) at the molecular level. The present invention in many different forms can be used to detect and measure potential drug substances and drug targets including those made by combinatorial chemistry. Utilizing the present invention, many different types of screening assays can be developed. For example, screening and characterization assays can be developed with the present invention for (1) the identification and characterization of drug targets and (2) developing specific assays for screening of pharmaceutical agents where the target is the basis of the assay.

As a result of the Human Genome Project, many genes have been identified and a large number of these genes encode potential drug targets. In addition, many genes of pathogenic organisms responsible for human and animal diseases have also been identified. Functional genomics is the field of determining the function of these genes and the proteins that they code for. Gene expression and protein expression assays can be developed with the present invention to determine which of these may be targets. In addition, drug target-based screening assays can be developed to screen for new pharmaceutical agents. Drug targets are structural components, enzymes, metabolic pathways, signaling pathways, or any other biological component or system upon which the pharmaceutical agent can modulate to a product effect. In most instances, a drug target interacts with one or more intracellular macromolecules in vivo to carry out its biological function(s). A common strategy in drug screening is to identity a compound that can interfere with these interactions.

The present invention provides a new signal generation and detection system for pharmaceutical drug target and pharmaceutical drug agent discovery and development. Compared to the art known label and detection techniques used currently in the art of pharmaceutical drug discovery and drug target identification, the present invention has several advantages including improved detection sensitivity, greater ease of use, broader applicability, greater robustness, and is less costly. The present invention provides a very stable and easy to detect light scattering signal in many different types of drug target and drug agent assays. The waveguides of the present invention in various embodiments provide signals that is so sensitive that very small arrays or miniaturized reaction and sample vessels can be used for analysis. The miniaturization of the sample devices and waveguides allows for a substantial decrease in the cost of the assays and time needed, and thus greatly accelerates the rate and cost efficiency at which many thousands of assays can be performed.

Many different types of in vitro biochemical or cell-based assays can be developed with the present invention to test for potential pharmaceutical agents. Assays which utilize drug targets such as cell surface receptors, intra-cellular receptors, intra-cellular signaling proteins, G-protein coupled receptors, ion channels, enzymes including proteases and protein kinases, DNA binding proteins, nucleic acids, and hormones can be used to identify and characterize new pharmaceutical agents. The samples being analyzed can include but are not limited to individual or multiple cells, cellular lysates, tissue samples, and membrane preparations. Many of the assay formats that can be adapted for use with the waveguides of the present invention are those currently in use in biological, biochemical, and medical diagnostic assays. These include competitive and noncompetitive assays, homogeneous assays, solid-phase microwells, arrays, and microfluidic chambers to detect and measure pharmaceutical agent binding activity and/or modulating effects upon a drug target system.

The basic principle of the assays used to identify compounds that interfere with the interaction between a drug target and its intracellular interacting partner or partners involves preparing a reaction mixture containing the drug target, and the interacting partner (e.g. a cell extract) under conditions and for a time sufficient to allow the two to interact and bind, thus forming a complex. In order to test a compound for inhibitory activity, the reaction mixture is prepared in the presence and absence of the test compound. The test compound may be initially included in the reaction mixture, or may be added at a time subsequent to the addition of drug target and its intracellular interacting partner. Control reaction mixtures are incubated without the test compound or with a placebo. The formation of any complexes between the drug target and the intracellular interacting partner is then detected. The formation of a complex in the control reaction, but not in the reaction mixture containing the test compound, indicates that the compound interferes with the interaction of the drug target and the interacting partner.

The assay for compounds that interfere with the interaction of a drug target and interacting partners can be conducted in a heterogeneous or homogeneous format. Heterogeneous assays involve anchoring either the drug target or the binding partner onto a solid phase and detecting complexes anchored on the solid phase at the end of the reaction. In homogeneous assays, the entire reaction is carried out in a liquid phase. In either approach, the order of addition of reactants can be varied to obtain different information about the compounds being tested. For example, test compounds that interfere with the interaction between the drug target and the interacting partners, e.g., by competition, can be identified by conducting the reaction in the presence of the test substance; i.e., by adding the test substance to the reaction mixture prior to or simultaneously with the drug target and intracellular interacting partner. Alternatively, test compounds that disrupt preformed complexes, e.g., compounds with higher binding constants that displace one of the components from the complex, can be tested by adding the test compound to the reaction mixture after complexes have been formed. The various formats are described briefly below.

In a heterogeneous assay system, either the drug target or the interacting partner, is anchored onto a solid surface, while the non-anchored species is labeled, either directly or indirectly. In practice, microtiter plates are conveniently utilized. The anchored species may be immobilized by non-covalent or covalent attachments. Non-covalent attachment may be accomplished simply by coating the solid surface with a solution of the drug target or interacting partner and drying. Alternatively, an immobilized antibody specific for the species to be anchored may be used to anchor the species to the solid surface. The surfaces may be prepared in advance and stored.

In order to conduct the assay, the partner of the immobilized species is exposed to the coated surface with or without the test compound. After the reaction is complete, unreacted components are removed (e.g., by washing) and any complexes formed will remain immobilized on the solid surface. The detection of complexes anchored on the solid surface can be accomplished in a number of ways. Where the non-immobilized species is pre-labeled, the detection of label immobilized on the surface indicates that complexes were formed. Where the non-immobilized species is not pre-labeled, an indirect label can be used to detect complexes anchored on the surface; e.g., using a labeled antibody specific for the initially non-immobilized species (the antibody, in turn, may be directly labeled or indirectly labeled with a labeled anti-Ig antibody). Depending upon the order of addition of reaction components, test compounds which inhibit complex formation or which disrupt preformed complexes can be detected.

Alternatively, the reaction can be conducted in a liquid phase in the presence or absence of the test compound, the reaction products separated from unreacted components, and complexes detected; e.g., using an immobilized antibody specific for one of the interacting components to anchor any complexes formed in solution, and a labeled antibody specific for the other partner to detect anchored complexes. Depending upon the order of addition of reactants to the liquid phase, test compounds which inhibit complex or which disrupt preformed complexes can be identified.

In an alternate embodiment of the invention, a homogeneous assay can be used. In this approach, a preformed complex of a drug target and the interacting partner is prepared in which either the drug target or its interacting partners is labeled. The addition of a test substance that competes with and displaces one of the species from the preformed complex will result in the generation of a signal above background. In this assay, test substances which disrupt drug target intracellular interacting partner interaction can be identified. To form a waveguide, a light transmissive layer is added to the surface above which the assay reaction occurs while excess liquid may be removed by evaporation and/or drying by heat.

### 6. EXAMPLE

The following examples demonstrate (i) an assay for the detection and quantitation of messenger RNA in a cell type; and (ii) an assay for the detection and quantitation of specific proteins in a sample; both using a waveguide of the invention formed on top of an array.

### 6.1 TWO-COLOR NUCLEIC ACID ASSAY

This assay demonstrates the detection and qunatitation of expression of 96 genes in the human placenta. In this assay, the probe nucleic acids comprising sequences complementary to 96 genes were deposited on an microarray for hybridization with complementary DNAs prepared from total RNA isolated from human placenta. Two sets of secondary binding pairs were used: biotin and fluorescein isothiocyante (FITC), and their respective antibodies. cDNAs were labeled enzymatically with biotin and fluorescein by incorporation of nucleosides derivatized with biotin or FITC. Two populations of light scattering particles were used: silver RLS particles (60 nm in diameter) attached to anti-FITC antibodies and gold RLS particles (80 nm in diameter) attached to anti-biotin antibodies. After the assay is completed, a light transmissive coating is formed on top of the array above the areas where the assays were carried out to form a waveguide. The waveguide was illuminated by non-evanescent light according to a method of the invention described in Section 5.2. Light is coupled to the slide via one of the edges at an angle that is greater than the critical angle at the interface between the glass slide and the coating. Different colored light scattered by the silver particles and the gold particles were visibly detected using a device similar to that depicted in FIG. 15, and the images of the light scattering particles in the waveguide were captured by a modified commercial photographic film scanning device as described in Section 5.2.

### 6.1.1 Array Preparation and Layout

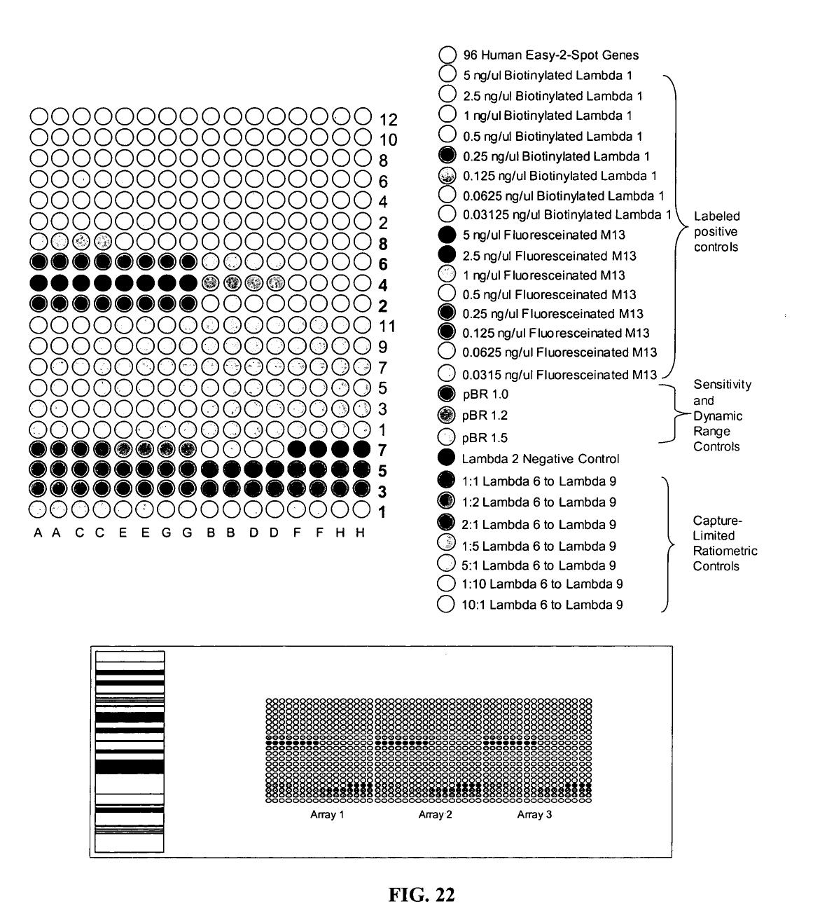

Coming CMT-GAPS™ II slides with a bar-code for orientation were used to form the arrays. Three arrays of 20 rows×16 columns were used. Easy-to-Spot™ Gene Amplicon (Incyte Genomics) was spotted with 50 mM DNA each a total of 6 times per slide. Various controls were incorporated into the assay to monitor the hybridization and antibody binding reactions and to assist quantitation and comparison of the two color signals. Eight rows of positive, negative, hybridization and ratiometric controls were used in the array. See FIG. 22.

Hybridization Controls:

Spotted pBR322 amplicons hybridized to known copy number of biotinylated and fluoresceinated complementary pBR cDNA (1.0 kb (A7, C7), 1.2 kb (E7, G7), and 1.5 kb (B7, D7)) were generated in vitro. The same number of copies of each of the biotinylated and fluoresceinated hybridization control cDNAs was added to the hybridization mixture so that the Au/Ag ratio of these features should be 1 to 1.

Positive Controls:

5′-Biotinylated Lambda (A8-H8 and A6-H6) and 5′-fluoresceinated Ml 3 amplicons (A4-H4 and A2-H2) were spotted onto the array in a two-fold dilution series from 5 ng/μl to 0.3125 ng/μl.

Negative Controls:

Phage lambda amplicon were spotted down in F7 and H7.

Capture-limited Ratiometric Controls:

Lambda 6 and Lambda 9 amplicons were spotted down in known molar ratios of 1:1 (B5, D5, F5, H5), 1:2 (A5, C5, E5, G5, A3, C3, E3, G3), 2:1 (B3, D3, F3, H3), 1:5 (A1, C1), 5:1 (E1, G1), 1:10 (B1, D1) and 10:1 (F1, H1). Biotinylated Lambda 9 cDNA and flurosceinated Lambda 6 cDNA were hybridized in molar excess.

The array slides were crosslinked under UV light at 300 mJ/cm2 and baked for 2 hours at 80° C.

### 6.1.2 Assay Method

Biotin- and fluorescein (FITC)-incorporated cDNA were prepared from 0.5 μg of Human Placental First-Choice™ Total RNA (Ambion). The biotin and FITC labeled cDNAs and the appropriate in-house hybridization controls were added as a mixture to the slides for hybridization. Arrays were pre-hybridized in 5×SSC, 25% formamide for 5-45 minutes at 42° C. The prepared sample of cDNA and control cDNAs were hybridized overnight at 42° C. in 5×SSC 0.1% SDS, 25% formamide. After hybridization, the arrays were washed twice at 42° C. in 2×SSC, 0.1% SDS for 10 minutes each, once for 10 minutes at room temperature in 0.1×SSC, 0.1% SDS, and then three times in 0.×SSC for 1 minute each at room temperature. After the washing steps, the arrays were blocked for 2 minutes in a block buffer comprising caesin.

Anti-FITC silver and anti-biotin gold RLS particles were diluted to 2 OD each and added to the arrays for incubation at room temperature for 1 hour. After the step of RLS particle binding, the arrays were washed three times for 1 minute at room temperature in 0.1×SSC followed by a brief rinse in deionized water.

To form a waveguide, the array slides were dipped in 7.5% polyvinyl alcohol (PVA) solution such that a coating is formed on the slide covering the bound gold and silver particles. The coated array slide was allowed to dry in air for 30 minutes. The refractive index of the dried PVA solution was higher than that of the slide. The particles in the waveguide were illuminated by light coupled to the waveguide through one of its edges using an apparatus described in Section 5.2, and the waveguide was imaged using the modified Cannon photographic film scanner as described in Section 5.2.

### 6.2 PROTEIN SANDWICH-TYPE ASSAY ON AN ARRAY

This assay demonstrates the detection and quantitation of 15 different cytokines on an array that comprises a first antibody for capturing specifically each of the different cytokines onto a spatially discrete area. The captured cytokines were then each specifically detected by a second set of antibodies, thereby forming a sandwich.

Each of the second antibodies were labeled with biotin. Anti-biotin antibodies labeled with gold RLS particles were then added to the array for binding to the second set of antibodies. After the assay is completed, a light transmissive coating is added on top of the array above the divided areas where the assays were carried out to form a waveguide. The waveguide was illuminated by the methods of the invention as described in Section 5.2. Light scattered by the gold particles were detected and the images of the light scattering particles in the waveguide were captured by the modified Cannon film scanner.

### 6.2.1 Array Preparation and layout

A 384 well-polypropylene plate was set up as a source plate for use with a 4-pin set—SMP Telechem (available from TeleChem International, Inc., Sunnyvale, Calif.).

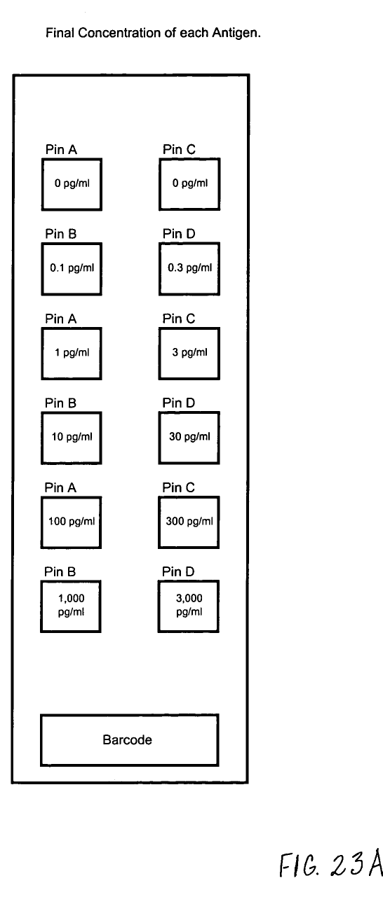

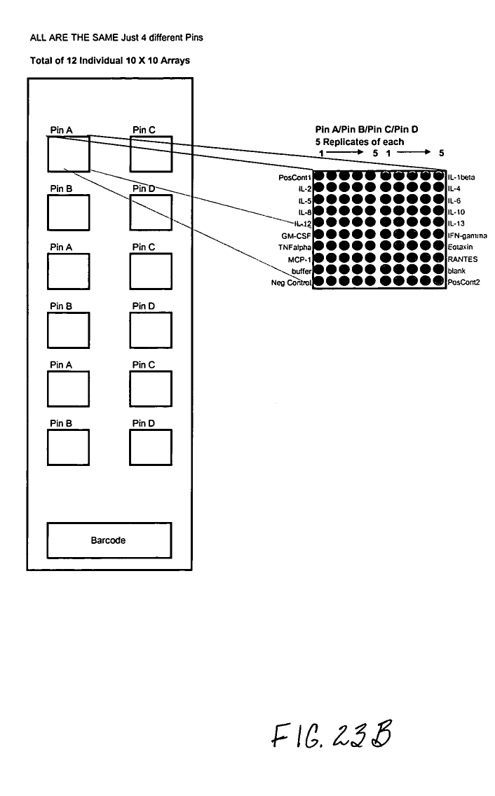

Twelve individual arrays consisting of 10×10 spots were printed onto a slide using a set. of 15 first analyte capture antibodies. See FIG. 23A for the layout of the arrays on the slide (distance between arrays 9 mm), and the spots within each array (spot distance 0.4 mm). Five replicates were set up for each antibody in each array. The following concentrations of first analyte capture antibodies were used in printing the array:

| Capture | |
|---|---|
| Antibodies | Concentrations |
| IL-1 beta | 200 ug/ml in PBS with 500 ug/ml bovine serum albumin |
| IL-4 | 200 ug/ml in PBS with 500 ug/ml bovine serum albumin |
| IL-6 | 200 ug/ml in PBS with 500 ug/ml bovine serum albumin |
| IL-10 | 200 ug/ml in PBS with 500 ug/ml bovine serum albumin |
| IL-13 | 200 ug/ml in PBS with 500 ug/ml bovine serum albumin |
| IFN-gamma | 200 ug/ml in PBS with 500 ug/ml bovine serum albumin |
| Eotaxin | 200 ug/ml in PBS with 100 ug/ml bovine serum albumin |
| RANTES | 50 ug/ml in PBS with 500 ug/ml bovine serum albumin |
| IL-2 | 200 ug/ml in PBS with 500 ug/ml bovine serum albumin |
| IL-5 | 200 ug/ml in PBS with 500 ug/ml bovine serum albumin |
| IL-8 | 200 ug/ml in PBS with 500 ug/ml bovine serum albumin |
| IL-12 | 200 ug/ml in PBS with 500 ug/ml bovine serum albumin |
| GM-CSF | 200 ug/ml in PBS with 500 ug/ml bovine serum albumin |
| TNFalpha | 200 ug/ml in PBS with 500 ug/ml bovine serum albumin |
| MCP-1 | 200 ug/ml in PBS with 100 ug/ml bovine serum albumin |
| Blank | Empty |
| Positive | 250 ug/ml mouse IgG with 0.5 ug/ml biotinylated mouse |
| control 1 | IgG and 500 ug/ml bovine serum albumin |
| Positive | 250 ug/ml mouse IgG with 0.5 ug/ml biotinylated mouse |
| control 2 | IgG and 500 ug/ml bovine serum albumin |
| Buffer | PBS with bovine serum albumin |
| Negative | 250 ug/ml mouse IgG |
| control | |

The printing condition was-done at 70% relative humidity at 78-80° F. after 15 pre-prints on CMT GAPS. After printing, the slides were stored in a storage box and placed in foil pouch with dessicant and incubated at 41 45° C. for 5 minutes. The pouch was removed from incubator and then sealed until use.

### 6.2.2 Assay Procedure

A slide divider was used to partition the individual arrays to accommodate each sample. Two series of serial dilution of an analyte cocktail (from 3000 pg of each cytokine per ml to 0.3 pg/ml and 1000 pg/ml to 0.1 pg/ml) were added to the arrays as shown in FIG. 23B. Negative controls containing no cytokines were also set up on the slide. The following 15 different cytokines were present in the analyte cocktail: IL-1β, IL-4, IL-6, IL-10, IL-13, IFN-γ, eotaxin, RANTES, IL-2, IL-5, IL-8, IL-12, GM-CSF, TNFα and MCP-1.

The assay was carried out on the arrays as follows:

Add 300 μl Pierce blocking solution per array on the divided slide.

Incubate for 1 hour at room temperature.

Flick and aspirate contents.

Add 50 μl analyte cocktail per array.

Incubate for 1 hour at room temperature covered with plate sealer.

Flick contents and wash four times with an aqueous wash solution.

Aspirate or flick out final wash.

Add 50 μl biotinylated detection antibody cocktail to each array. The detection antibody cocktail contains antibodies to the following cytokines, and their respective concentrations:

| Detection antibodies | Concentration |
|---|---|
| IL-1 beta | 0.5 ug/ml in Blocking Solution with 0.5 mg/ml Non Specific Goat IgG |
| IL-4 | 0.5 ug/ml in Blocking Solution with 0.5 mg/ml Non Specific Goat IgG |
| IL-6 | 0.5 ug/ml in Blocking Solution with 0.5 mg/ml Non Specific Goat IgG |
| IL-10 | 0.5 ug/ml in Blocking Solution with 0.5 mg/ml Non Specific Goat IgG |
| IL-13 | 0.5 ug/ml in Blocking Solution with 0.5 mg/ml Non Specific Goat IgG |
| IFN-gamma | 0.5 ug/ml in Blocking Solution with 0.5 mg/ml Non Specific Goat IgG |
| Eotaxin | 0.5 ug/ml in Blocking Solution with 0.5 mg/ml Non Specific Goat IgG |
| RANTES | 0.1 ug/ml in Blocking Solution with 0.5 mg/ml Non Specific Goat IgG |
| IL-2 | 0.5 ug/ml in Blocking Solution with 0.5 mg/ml Non Specific Goat IgG |
| IL-5 | 0.5 ug/ml in Blocking Solution with 0.5 mg/ml Non Specific Goat IgG |
| IL-8 | 0.5 ug/ml in Blocking Solution with 0.5 mg/ml Non Specific Goat IgG |
| IL-12 | 0.5 ug/ml in Blocking Solution with 0.5 mg/ml Non Specific Goat IgG |
| GM-CSF | 0.5 ug/ml in Blocking Solution with 0.5 mg/ml Non Specific Goat IgG |
| TNFalpha | 0.5 ug/ml in Blocking Solution with 0.5 mg/ml Non Specific Goat IgG |
| MCP-1 | 0.5 ug/ml in Blocking Solution with 0.5 mg/ml Non Specific Goat IgG |

Incubate for 1 hour at room temperature covered with plate sealer.

Flick contents wash four times with wash solution.

Aspirate or flick out final wash.

Add 300 μl of blocking solution per array and incubate for 15 minutes.

During incubation, dilute 80 nm anti-biotin antibody-coated gold RLS particles in protein RLS diluent: 1 part anti-biotin antibody-coated gold RLS particles at 6 OD to 3 parts protein RLS diluent.

Flick and aspirate contents.

Add 50 μl diluted anti-biotin antibody-coated gold RLS particles per array.

Incubate for 1 hour at room temperature covered with plate sealer.

Flick out and wash 3× with wash solution.

Place slides in slide mailer with wash solution and incubate 30 minutes inverting every 10-15 minutes.

Remove slides from slide mailer and rinse slides 3× with deionized water.

The slides with dried with compressed air stream.

The slides were coated with a 7.5% PVA solution and allowed to dry.

The slides were imaged on the modified Cannon film scanner as described in Section 5.2.

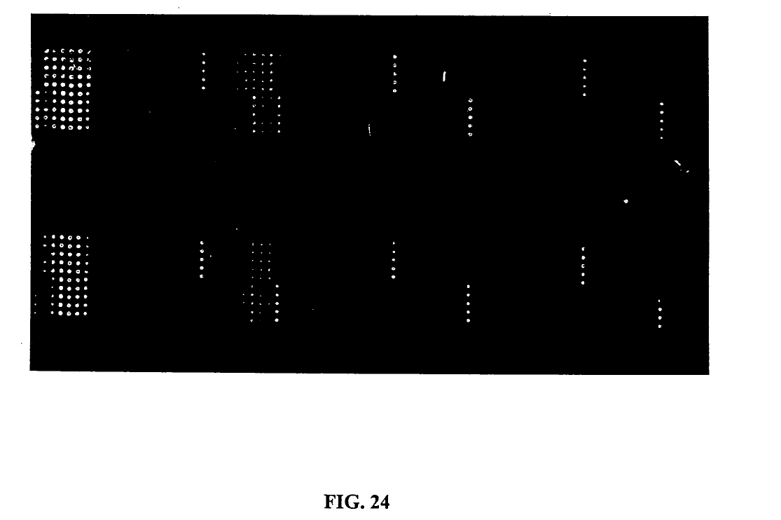

An example of images obtained from the slides is shown in FIG. 24.

One skilled in the art will readily appreciate that the present invention is well adapted to carry out the objects and obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications may be made to the invention disclosed herein without departing from the scope and spirit of the invention. For example, using other sample devices and/or labeling techniques are all within the scope of the present invention. Thus, such additional embodiments are within the scope of the present invention and the following claims.

In addition, where features or aspects of the invention are described in terms of Markush groups or other grouping of alternatives, those skilled in the art will recognize that the invention is also thereby described in terms of any individual member or subgroup of members of the Markush group or other group.

Where a component or limitation is described with a variety of different possible numbers or dimensions associated with that component or limitation, in additional embodiments, the component or limitation is in a range specified by taking any two of the particular values provided as the endpoints of the range. The range includes the endpoints unless clearly indicated to the contrary.

1. A waveguide comprising
a first optically transmissive material that forms an interface with a second optically transmissive material, wherein the refractive index of said second material is greater than or equal to the refractive index of said first material; and
one or more populations of scattered light detectable particles of a dimension between about 1 and about 500 nm inclusive that are bound to an analyte, wherein said particles are distributed in said second material such that said particles are illuminated by non-evanescent light and produce detectable scattered light in said waveguide.

2. The waveguide of claim 1, wherein each population of particles binds to a different predetermined analyte, and has a particle type configuration distinguishable from other populations by its predetermined scattered light detectable property.

3. The waveguide of claim 1 or 2, wherein said particles comprise a metal, a metal compound, a semiconductor, or a superconductor.

4. The waveguide of claim 1 or 2, wherein said particles comprise gold, silver, or both gold and silver.

5. The waveguide of claim 1 or 2, wherein said particles exhibits plasmon resonant light scattering.

6. The waveguide of claim 1 or 2, wherein said one or more populations of particles are separately spherical, non-spherical, symmetric, asymmetric, elliposoidal, cylindrical, cubical, tetrahedral, polyhedral, or pyramidal.

7. The waveguide of claim 1 or 2, wherein said particles are of a dimension in the range of about 10 to about 200 nm inclusive, about 20 to about 200 nm inclusive, about 40 to about 120 nm inclusive, about 80 to about 120 nm inclusive, about 1 to about 10 nm inclusive, about 11 to about 40 nm inclusive, about 100 to about 250 nm inclusive, or about 40 to about 80 nm inclusive.

8. The waveguide of claim 1 or 2, wherein said particles form aggregates, and wherein light scattered by said aggregates is detectably different from light scattered by individual particles.

9. The waveguide of claim 1 or 2, wherein said particles are bound to a probe that binds said analyte directly.

10. The waveguide of claim 1 or 2, wherein said particles are indirectly bound to said analyte via a probe and one or more members of at least one secondary binding pair.

11. The waveguide of claim 10, wherein said secondary binding pair comprises an antigen, a hapten, a polyclonal antibody, a monoclonal antibody, a lectin, a carbohydrate, a polynucleotide, a receptor, biotin, avidin, streptavidin, digoxigenin, or fluorescein.

12. The waveguide of claim 1 or 2, wherein said analyte is a polynucleotide, a DNA molecule, a RNA molecule, a PNA molecule, a polypeptide, a carbohydrate, a glycoprotein, a lipid, a glycolipid, a combinatorially-synthesized molecule, a natural product, a pharmaceutical agent, a chromosome, a cell organelle, a virus, a bacterium, a protozoan, a fungus, a pathogen, a microorganism, a single cell organism, or a cell of a multicellular organism.

13. The waveguide of claim 1 or 2, wherein one or more surfaces of said waveguide are adapted to couple light into said waveguide.

14. The waveguide of claim 1 or 2, wherein one or more surfaces of said waveguide is coupled to a prism, is coupled to an optical grating, or is coated with a reflective material.

15. The waveguide of claim 1 or 2, wherein one or more surfaces of said waveguide are adapted to couple scattered light from said waveguide to a sensor or an eyepiece.

16. The waveguide of claim 1 or 2, wherein said first material and second material separately comprise glass, quartz, silicon dioxide, silica, borosilicate, barium silicate, calcium fluoride, magnesium fluoride, a polystyrene, a polycarbonate, a polyvinyl chloride, a polyvinyl alcohol, a polyethylene, a polytetrafluroethylene, a perfluroalkoxy, a polyvinylidene fluoride, an acrylate, a polyurethane, beta-pinene, a polyolefin, a cyclic olefin, cellulose acetate butyrate, benocyclobutene, a polysulfone, a polyester, a polyimide, a siloxane, an epoxide, a metal oxide, a silicon alkoxide, or a titanium alkoxide.

17. The waveguide of claim 1 or 2, wherein said first material is configured to form a first layer and said second material is configured to form a second layer that interfaces with said first layer to form a planar structure.

18. The waveguide of claim 17, wherein said first layer is configured to comprise one or more spatially addressable sites.

19. The waveguide of claim 17, wherein said particles are deposited on the surface of said first layer that forms said interface with said second layer.

20. The waveguide of claim 17, wherein said first layer is sandwiched by said second layer, and a third layer which comprises said second optically transmissive material.

21. The waveguide of claim 17, wherein said second layer is a coating that is applied to said first layer.

22. The waveguide of claim 17, wherein said first layer comprises silica and said second layer comprises an acryate, a polyurethane, a polyvinyl alcohol, or beta-pinene.

23. The waveguide of claim 17, wherein said first layer is a slide, and one or more edges of said slide are adapted to couple light into said waveguide.

24. A method for detecting an analyte in a sample comprising the steps of:
(a) contacting said sample with one or more populations of scattered light detectable particles that bind to said analyte, wherein said particles are of a dimension between 1 and 500 nm inclusive;
(b) forming a planar waveguide comprising an interface between a first optically transmissive layer and a second optically transmissive layer, wherein said particles are present in said second layer, and wherein the refractive index of said second layer is greater than or equal to the refractive index of said first layer;
(c) illuminating said particles in said waveguide with non-evanescent light under conditions which produces scattered light from said particles; and
(d) detecting light scattered by (i) said populations of particles bound with analyte; or (ii) said populations of particles not bound with analyte; or (iii) both (i) and (ii), as a measure of the presence of said analyte in said sample.

25. The method of claim 24, comprising prior to said contacting step, depositing either said sample, said particles, or both said sample and said particles on a surface of said first optically transmissive layer.

26. The method of claim 24, wherein the step of forming said waveguide comprises contacting said first optically transmissive layer with a precursor of said second optically transmissive layer which is in liquid phase or gaseous phase.

27. The method of claim 24, wherein the step of forming said waveguide comprises curing said second optically transmissive layer.

28. The method of claim 24, further comprising the step of depositing said particles on a surface of a first optically transmissive layer prior to forming said waveguide, such that said particles are present at said interface.

29. The method of claim 24, further comprising the step of distributing said particles in said second optically transmissive layer or a precusor of said second optically transmissive layer, prior to forming said waveguide.

30. The method of claim 24, wherein said illuminating produces scattered light from said particle and in which light scattered from one or more said particles can be detected by a human eye with less than 500 times magnification and without electronic amplification.

31. The method of claim 24, wherein said illuminating comprises illuminating said particles with monochromatic light, polychromatic light, white light, sunlight, or laser light.

32. The method of claim 24, wherein said illuminating comprises coupling incident light from a light source into said waveguide at an angle that creates total internal reflection at one or more exterior surfaces of said waveguide but not at said interfaces of said first layer and said second layer.

33. The method of claim 24, wherein said illuminating comprises coupling incident light from a light source to said first layer of said waveguide.

34. The method of claim 24, wherein said illuminating is provided by one or more light emitting diodes that are focused with one or more optical elements along an edge of said waveguide.

35. The method of claim 24, wherein said detecting comprises magnification with a microscope 2 to 500 times or 10 to l00 times.

36. The method of claim 24, wherein said detecting comprises providing an integrated light intensity measurement, particle counting, or both.

37. The method of claim 24, wherein said detecting comprises (i) forming an image, and (ii) viewing said image, recording said image, analyzing said image by a computer, counting particles in said image, or a combination of the foregoing.

38. The method of claim 24, wherein said detecting comprises use of a film camera, a video camera, confocal microscopy, a photodiode, a photodiode array, a photomultiplier tube, a CMOS, or a charge-coupled device.

39. The method of claim 24, wherein said illuminating step comprises providing incident light that is non-polarized, polarized, pulsed, constant, coherent, or noncoherent.

40. The method of claim 24, wherein said illuminating step comprises use of light from a filament lamp source, an arc lamp, a discharge lamp source, a laser, or a light emitting diode.

41. An apparatus for illuminating a planar waveguide and detecting scattered light produced by scattered light detectable particles in said waveguide, comprising:
a planar waveguide in a holder adapted to hold said waveguide;
an illumination system comprising a light source directed at said waveguide; and
a scattered light detection system cooperating with said holder and illumination system to detect light scattered from said particles,
wherein said waveguide comprises a first optically transmissive layer that forms an interface on at least one side with a second optically transmissive layer, such that scattered light detectable particles in said waveguide are illuminated by non-evanescent light.

42. The apparatus of claim 41, wherein said illumination system further comprises one or more optical elements such that light from said light source is directed at a target surface of said waveguide at an angle that creates total internal reflection at one or more exterior surfaces of said waveguide but not at said interfaces of said first layer and said second layer.

43. The apparatus of claim 41, wherein said holder comprises X and Y stages for precisely positioning said waveguide with respect to said illumination system and said detection system.

44. The apparatus of claim 41, wherein said illumination system comprises a plurality of light emitting diodes focused on a target surface of said waveguide.

45. The apparatus of claim 41, wherein said detection system comprises an eyepiece, a film camera, a video camera, a photomultiplier, a photodiode, a photodiode array or a charge coupled device.

46. The apparatus of claim 41, wherein said illumination system comprises a broad-band light source and said apparatus further comprises a plurality of individually selectable spectrally discriminative light filters disposed in at least one of the illumination system or detection system.

47. The apparatus of claim 41, wherein said illumination system comprises a light source and cylindrical lens configured to focus a line of light along an edge of said first layer of said waveguide.

48. The apparatus of claim 41, wherein said detection system comprises light detector focused on a surface of said waveguide proximate to said second layer, and defines a field of view extending from said surface, into said second layer of said waveguide and terminating at or before said interface with said first layer.
